(19) United States
(12) Patent Application Publication
(10) Pub. No.: US 2002/0075563 A1
(43) Pub. Date: Jun. 20, 2002

(54) Camera for microscope and microscope system

(75) Inventors: Shinichiro Aizaki, Ome-shi (JP); Jitsunari Kojima, Hachioji-shi (JP); Hideyuki Masuyama, Hachioji-shi (JP); Mitsuhiko Saito, Hachioji-shi (JP); Hitoshi Ueda, Hachioji-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/773,345

(22) Filed: Jan. 31, 2001

(30) Foreign Application Priority Data
Feb. 4, 2000 (JP) 2000-028320
Feb. 4, 2000 (JP) 2000-028324

(51) Int. Cl. G02B 21/36; G02B 23/00

(52) U.S. Cl. 359/363; 359/368

(57) ABSTRACT

There is disclosed a camera for a microscope, connected to the microscope including at least one port for outputting an image from an objective lens, for picking up an image outputted from the port, the camera comprising an image pickup element for picking up the image outputted from the port, a display direction controlling section for converting a display direction of the image picked up by the image pickup element to a predetermined display direction, a display direction setting section for setting the predetermined display direction with respect to the display direction controlling section, and a display section for displaying an image having the display direction converted by the display direction controlling section.

### CROSS-REFERENCE TO RELATED APPLICATIONS

This application is based upon and claims the benefit of priority from the prior Japanese Patent Applications No. 2000-028320, filed Feb. 4, 2000; and No. 2000-028324, filed Feb. 4, 2000, the entire contents of which are incorporated herein by reference.

### BACKGROUND OF THE INVENTION

The present invention relates to a camera for a microscope, attached to, for example, an erected or inverted microscope, for picking up an observation image observed by the microscope, and a microscope system including a display for displaying the observation image of the microscope.

FIG. 40 is a side view showing a conventional configuration of an erected microscope provided with an electronic camera (digital camera) for the microscope. A microscope main body 1 is provided with a vertically movable stage 2, and a sample 3 is laid on the stage 2. A revolver 5 to which an objective lens 4 is attached is rotatably disposed above the stage 2 in the microscope main body 1. Moreover, a triple lens tube 6 is disposed in an upper part of the microscope main body 1, an eyepiece 7 is attached to the triple lens tube 6, and an electronic camera main body 9 of the electronic camera for the microscope is attached to a port 6a of the triple lens tube 6 via an adapter 8 for television. An operation unit 9a is connected to the electronic camera main body 9 via a cord 9b.

FIG. 41 is a front view of the electronic camera for the microscope. As shown in FIG. 41, a liquid crystal monitor display 10 is integrally attached to the electronic camera main body 9 via a main body fastening member 11. This liquid crystal monitor display 10 is provided with a monitor screen. This monitor screen is disposed so as to be inclined forward by a predetermined angle beforehand, so that an observer can easily see the monitor screen even when the electronic camera main body 9 is attached to a position higher than that of the observer.

In the electronic camera for the microscope, the observation image of the sample 3 enlarged by the microscope is picked up by the electronic camera main body 9, and the observation image picked up by the electronic camera main body 9 or the observation image of the sample 3 enlarged by the microscope is displayed in the monitor screen of the liquid crystal monitor display 10, so that observation of the sample 3 is possible.

FIG. 42 is a side view showing a configuration of an inverted microscope provided with the electronic camera for the microscope. When the electronic camera for the microscope is attached, for example, to the inverted microscope shown in FIG. 42, a problem occurs in a display direction of a monitor image. In the inverted microscope, a stage 13 is disposed on a microscope main body 12, and the sample 3 is laid on the stage 13. An objective lens 14 is disposed under the stage 13, and an observation optical system disposed on an optical axis of the objective lens 14 is optically connected to a triple lens tube 15. An eyepiece 16 is attached to the triple lens tube 15. Moreover, similarly as the erected microscope, the electronic camera main body 9 of the electronic camera for the microscope can directly be attached to a port 15a of the triple lens tube 15 via the television adapter 8.

Furthermore, respective ports (optical paths) 17a to 17c for photographing by a photograph camera and television camera are disposed in opposite side surfaces and front surface of the microscope main body 12. Additionally, the respective ports 17a, 17b of the opposite side surfaces of the microscope main body 12 are referred to as side ports. Respective optical systems are disposed in these ports 15a, 17a to 17c.

Therefore, when the observation image of the sample 3 enlarged by the inverted microscope is picked up, the electronic camera main body 9 is attached to any one of the ports 15a, 17a to 17c.

However, the display direction of the monitor image disadvantageously differs when the electronic camera main body 9 is directly attached to the port 15a, attached to the port 15a via the television adapter 8, and attached to any one of the ports 17a to 17c of the opposite side surfaces and front surface of the microscope main body 12.

Moreover, in the conventional art, the observer tries to look into the eyepiece to observe the observation image from the objective lens by the microscope. In recent years, however, with development of an image pickup element with a high performance such as CCD, a system has practically been used in which the observation image is picked up by the image pickup element, and the picked-up observation image is directly displayed in a monitor display, so that the eyepiece is omitted.

However, in the microscope system including the conventional monitor display, since only the image observed via the objective lens by the microscope is displayed in the monitor display, the observer has to perform various operations on a microscope side based on one's sense and experience. Therefore, the operation is troublesome, a difference in observation result is made by a degree of the observer's experience, and the system is not easily used.

### BRIEF SUMMARY OF THE INVENTION

An object of the present invention is to provide an electronic camera for a microscope, by which an observation image can be displayed in a display direction necessary for an observer even when the electronic camera is attached to any configuration unit such as respective ports different from one another in an image direction and a microscope adapter.

Another object of the present invention is to provide a microscope system in which an observation image and information effective for a system operation can be displayed in a display, and ease of use is improved.

To achieve the objects, according to the present invention, there is provided a camera for a microscope, connected to the microscope having at least one port for outputting an image from an objective lens, for picking up the image outputted from the port, the camera comprising an image pickup element for picking up the image outputted from the port, a display direction controller for converting a display direction of the image picked up by the image pickup element to a predetermined display direction, a display direction setter for setting the predetermined display direction with respect to the display direction controller, and a display for displaying the image having the display direction converted by the display direction controller.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a schematic diagram of an observation optical system in an inverted microscope according to an embodiment of the present invention.

FIG. 2 is a schematic diagram of an image in a primary image forming position of the observation optical system in a microscope main body of the microscope according to the embodiment of the present invention.

FIG. 3 is a schematic diagram of an observation image observed via an eyepiece in the microscope main body according to the embodiment of the present invention.

FIG. 4 is a schematic diagram of the image formed in a secondary image forming position via an adapter for television attached to a port in the microscope main body according to the embodiment of the present invention.

FIG. 5 is a view showing an image obtained from the port on the left side of the microscope main body according to the embodiment of the present invention.

FIG. 6 is a view showing an image obtained from the port on the right side of the microscope main body according to the embodiment of the present invention.

FIG. 7 is a view showing an image obtained from the port in the front surface of the microscope main body according to the embodiment of the present invention.

FIG. 8 is a side view showing an entire configuration in which an electronic camera for a microscope according to the embodiment of the present invention is attached to an erected microscope.

FIGS. 9A and 9B are views showing the entire configuration in which the electronic camera for the microscope according to the embodiment of the present invention is attached to an inverted microscope.

FIG. 10 is a block diagram showing the configuration of the electronic camera for the microscope according to the embodiment of the present invention.

FIG. 11 is a diagram showing a configuration of an operation input section according to the embodiment of the present invention.

FIG. 12 shows a display direction conversion table according to the embodiment of the present invention.

FIG. 13 is a schematic diagram showing a modification example of a display direction setter in the electronic camera for the microscope according to the embodiment of the present invention.

FIG. 14 is a diagram showing a camera-side electrode of the display direction setter according to the modification example of the embodiment of the present invention.

FIG. 15 is a block diagram showing a configuration of the electronic camera for the microscope according to the modification example of the embodiment of the present invention.

FIGS. 16A to 16E are diagrams showing port-side electrodes of the display direction setter in the electronic camera for the microscope according to the modification example of the embodiment of the present invention.

FIG. 17 is a table showing a relation between the electrode and a port position according to the modification example of the embodiment of the present invention.

FIGS. 18A and 18B are schematic diagrams showing positioning of the camera-side electrode of the electronic camera main body and port-side electrode in the respective ports or the television adapter according to the modification example of the embodiment of the present invention.

FIG. 19 is a side view showing the entire configuration in which the electronic camera for the microscope according to the embodiment of the present invention is attached to the inverted microscope.

FIG. 20 is a block diagram showing the configuration of the microscope electronic camera according to the embodiment of the present invention.

FIG. 21 is a table showing the port connected to the electronic camera of the embodiment of the present invention and a display conversion form with respect to a configuring unit ID.

FIG. 22 is a diagram showing a configuration of the modification example of an operation input section according to the embodiment of the present invention.

FIG. 23 is a diagram showing a configuration of a microscope system according to the embodiment of the present invention.

FIG. 24 is a diagram showing a display example in a display according to the embodiment of the present invention.

FIG. 25 is a diagram showing the configuration of the microscope system according to another embodiment of the present invention.

FIG. 26 is a diagram showing the configuration of the microscope system according to another embodiment of the present invention.

FIGS. 27A and 27B are diagrams showing the configuration of the microscope system according to another embodiment of the present invention.

FIGS. 28A and 28B are diagrams showing the configuration of the microscope system according to another embodiment of the present invention.

FIG. 29 is a diagram showing the configuration of the microscope system according to another embodiment of the present invention.

FIG. 30 is a diagram showing the configuration of the microscope system according to another embodiment of the present invention.

FIG. 31 is a diagram showing the display example in the display according to the embodiment of the present invention.

FIG. 32 is a diagram showing the configuration of the microscope system according to another embodiment of the present invention.

FIGS. 33A and 33B are diagrams showing the configuration of the microscope system according to another embodiment of the present invention.

FIG. 34 is a diagram showing the configuration of the microscope system according to another embodiment of the present invention.

FIG. 35 is a diagram showing the configuration of the microscope system according to another embodiment of the present invention.

FIG. 36 is a diagram showing the configuration of the microscope system according to another embodiment of the present invention.

FIGS. 37A and 37B are diagrams showing the configuration of the microscope system according to another embodiment of the present invention.

FIG. 38 is a diagram showing the configuration of the microscope system according to the embodiment of the present invention.

FIG. 39 is a diagram showing the configuration of the microscope system according to another embodiment of the present invention.

FIG. 40 is a side view showing a configuration of an erected microscope provided with the electronic camera for the microscope according to the embodiment of the present invention and a conventional example.

FIG. 41 is a front view showing the electronic camera for the microscope according to the embodiment of the present invention and the conventional example.

FIG. 42 is a side view showing a configuration of an inverted microscope provided with the electronic camera for the microscope according to the embodiment of the present invention and the conventional example.

### DETAILED DESCRIPTION OF THE INVENTION

An embodiment of the present invention will be described hereinafter with reference to the drawings.

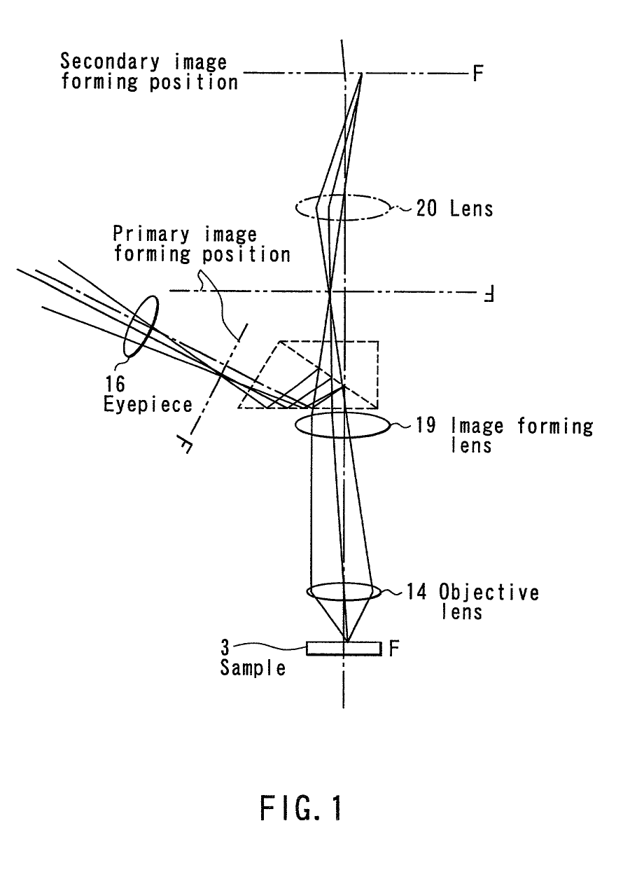

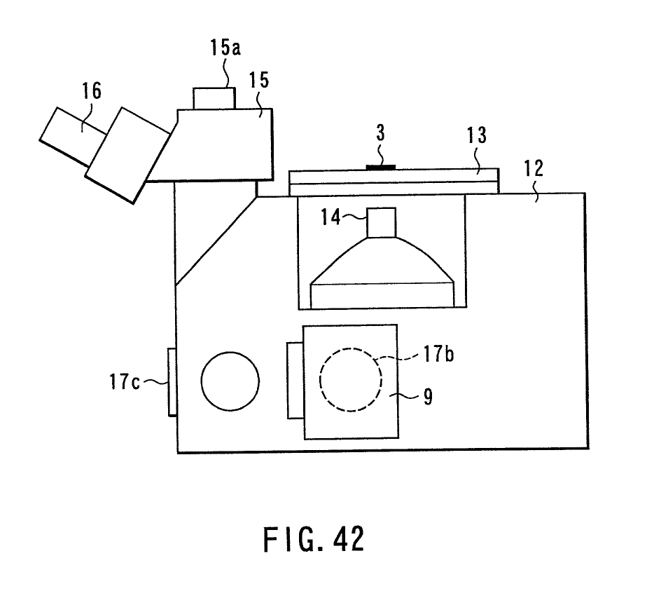

FIG. 1 is a schematic diagram of an observation optical system in an inverted microscope shown in FIG. 42. In this observation optical system, an image of a sample 3 (shown by character ‘F’ in FIG. 1) is formed in a primary image forming position via an image forming lens 19 from an objective lens 14.

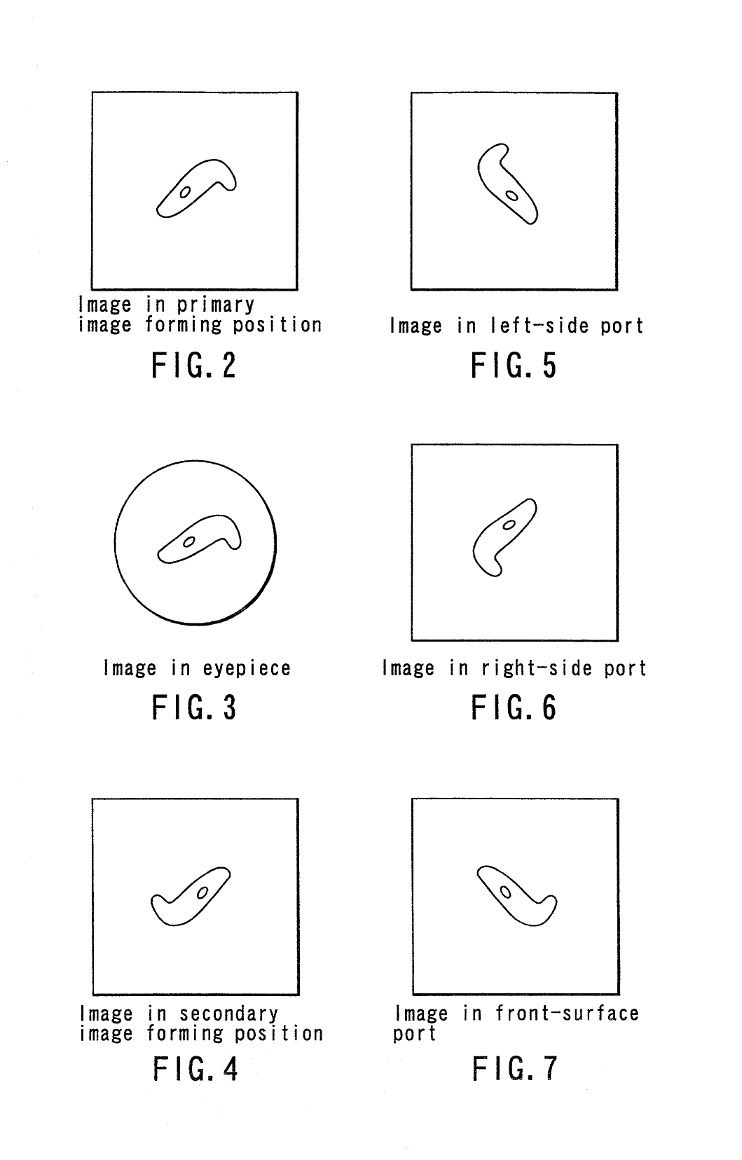

FIG. 2 is a schematic diagram of the image in the primary image forming position of the observation optical system in a microscope main body 12 of the microscope, and FIG. 3 is a schematic diagram of an observation image observed via an eyepiece 16 in the microscope main body 12. As shown in FIGS. 2 and 3, the image in the primary image forming position has the same display direction as that of the image (observation image) observed via the eyepiece 16.

FIG. 4 is a schematic diagram of the image formed in a secondary image forming position via an adapter for television attached to a port 15a in the microscope main body 12. Different from the image in the primary image forming position, the image formed in the secondary image forming position via a lens 20 of the television adapter attached to the port 15a has a display direction rotated by 180° from the observation image via the eyepiece 16 as shown in FIG. 4.

Furthermore, in the respective observation optical systems including respective ports 17a to 17c in opposite side surfaces and front surface of the microscope main body 12, when configuration s such as the number of included reflecting mirrors differ, respective images obtained via the respective ports 17a to 17c differ from one another in the display direction. For example, as shown in FIG. 5, the image obtained via the port 17a on the left side of the microscope main body 12 has a display direction rotated in the left direction by 90° with respect to the observation image via the eyepiece 16 shown in FIG. 3. Moreover, as shown in FIG. 6, the image obtained via the port 17b on the right side of the microscope main body 12 has a display direction rotated in the right direction by 90° and further horizontally reversed (front/back converted) with respect to the observation image via the eyepiece 16 shown in FIG. 3. Furthermore, as shown in FIG. 7, the image obtained via the port 17c in the front surface of the microscope main body 12 has a display direction vertically reversed, or {horizontally reversed (front/back converted)+rotated by 180°} with respect to the observation image via the eyepiece 16 shown in FIG. 3.

Therefore, when an electronic camera main body 9 is attached to one of the television adapter and any one of the respective ports 17a to 17c, the respective display directions of the observation images displayed in the monitor screen of a liquid crystal monitor display 10 seem to be different with respect to the image observed via the eyepiece 16 as viewed from an observer. In this case, it is difficult for the observer to frame or focus the image on the monitor screen of the liquid crystal monitor display 10, for example, during photography.

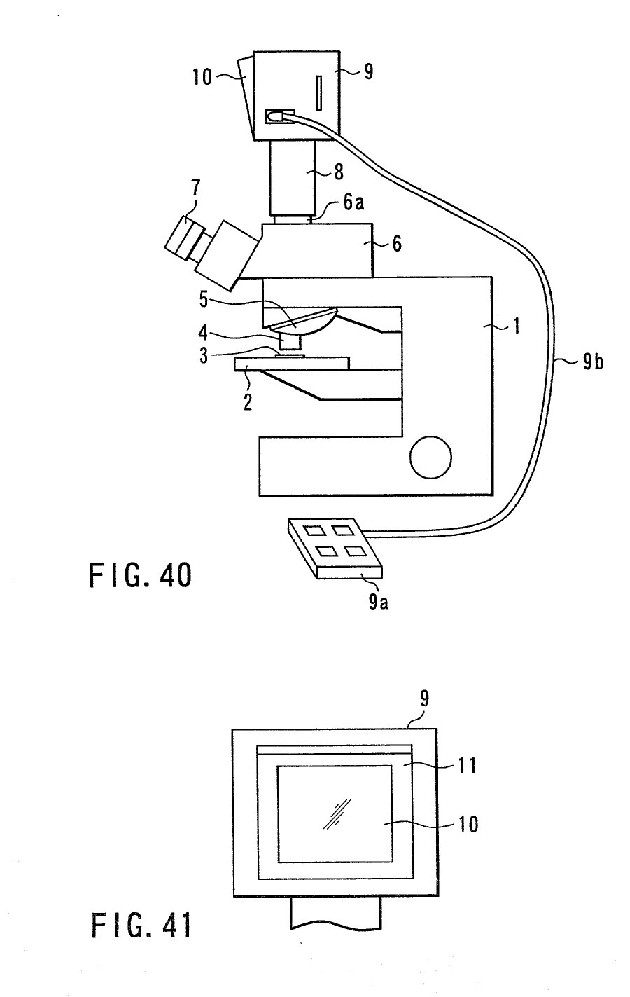

Moreover, also when the electronic camera for the microscope is attached to the erected microscope shown in FIG. 40, the problem similar to the aforementioned problem occurs with some microscope configuration unit with the electronic camera attached thereto. That is, in the microscope of FIG. 40, the position of the image pickup element of the electronic camera is the primary image forming position or the secondary image forming position of the microscope in accordance with the type of the television adapter 8,

For example, in the observation optical system of FIG. 1, with the television adapter including a lens corresponding to the lens 20, and the television adapter having no lens, the respective observation images of the microscope projected on the image pickup elements rotate from each other by 180°.

Therefore, for the observation image displayed in the monitor screen of the liquid crystal monitor display 10 of the electronic camera main body 9, the display direction sometimes differs with respect to the image observed via the eyepiece 16 in accordance with the television adapter type as viewed from the observer. Also in this case, it is difficult to frame or focus the image on the monitor screen of the liquid crystal monitor display 10, for example, during photography.

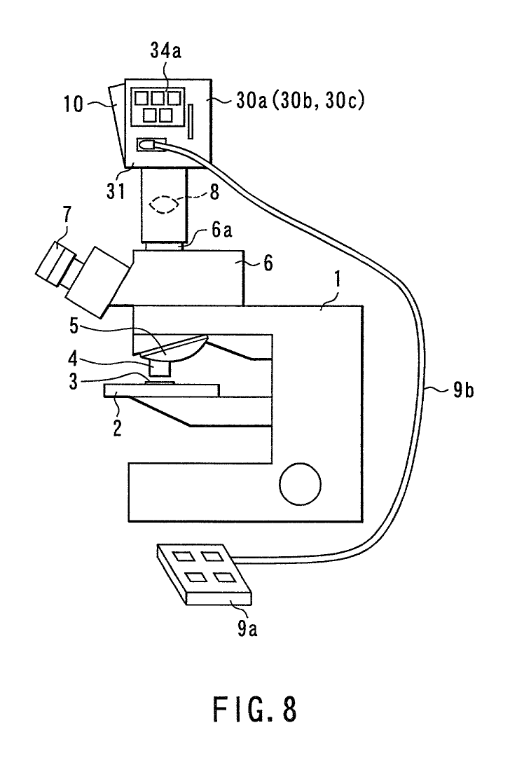

FIG. 8 is a side view showing an entire configuration in which the electronic camera for the microscope (digital camera) according to a first embodiment of the present invention is attached to the erected microscope. In FIG. 8, the same components as those of FIG. 40 are denoted with the same reference numerals. In FIG. 8, an electronic camera main body 30a is attached to a port 6a of a microscope main body 1 via the television adapter 8 with respect to the erected microscope. Additionally, the television adapter 8 may be removed from the microscope main body 1, so that the electronic camera main body 30a can directly be attached to the port 6a of the microscope main body 1.

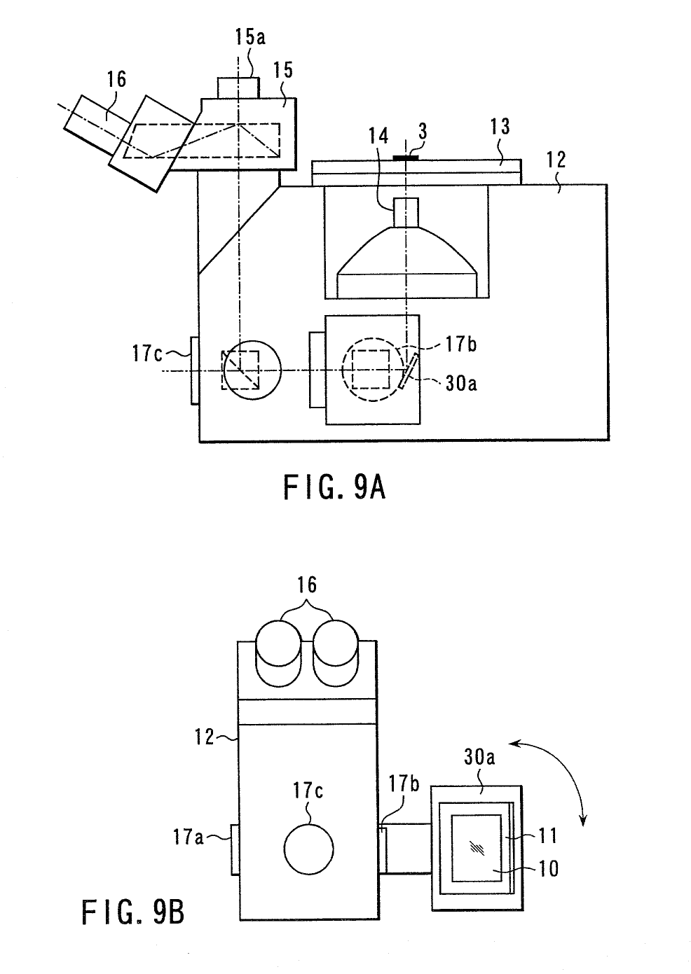

FIG. 9A is a side view showing the entire configuration in which the electronic camera for the microscope according to the first embodiment of the present invention is attached to an inverted microscope, and FIG. 9B is a front view. In FIGS. 9A, 9B, the same components as those of FIG. 42 are denoted with the same reference numerals. In FIGS. 9A and 9B, the electronic camera main body 30a is attached to the side port 17b on the right side (as faced) with respect to the inverted microscope. This electronic camera main body 30a can directly be attached to the port 15a of the microscope main body 12. Furthermore, the electronic camera main body 30a can be attached to the port 15a via the television adapter 8, and can also be attached to the left-side port 17a (on the left side as faced) or the front-surface port 17c.

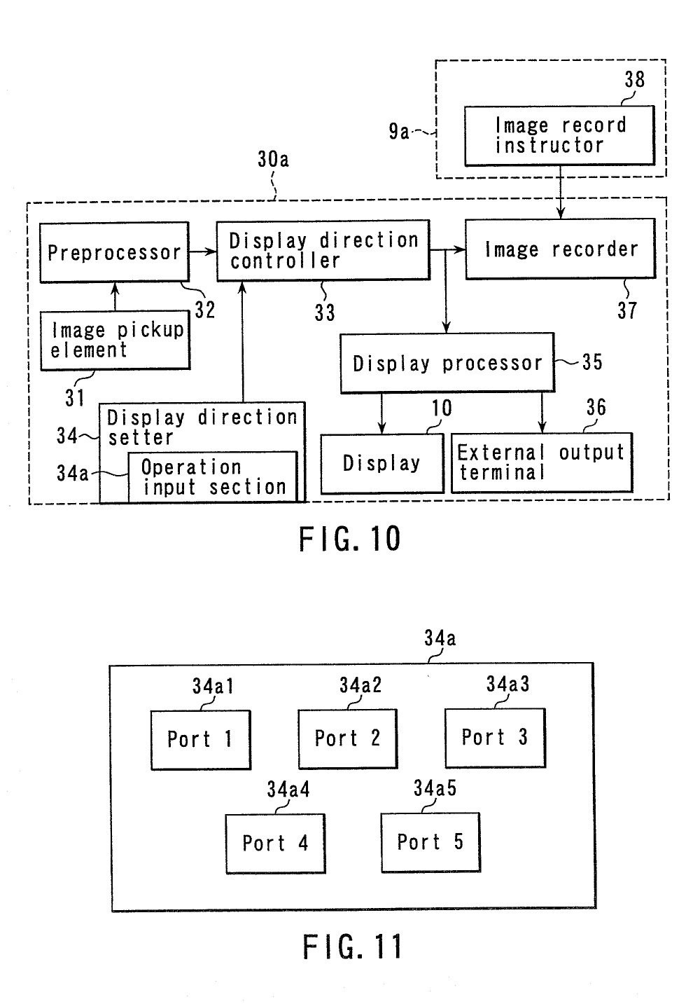

FIG. 10 is a block diagram showing the configuration of the electronic camera for the microscope. The electronic camera main body 30a is provided with an image pickup element 31 such as CCD, and an output terminal of the image pickup element 31 is connected to a display direction controller 33 via a preprocessor 32. The display direction controller 33 is connected to a display direction setter 34 and display processor 35. The display direction controller 33 and display direction setter 34 can arbitrarily change the direction and front/back of the image obtained by picking up the observation image.

The display direction setter 34 sets the direction of the observation image to be displayed on the monitor screen of the liquid crystal monitor display 10 with respect to the display direction controller 33. The display direction setter 34 has a function of setting arbitrary direction obtained by any combination of vertical reverse, {horizontal reverse (front/back conversion)+180° rotation}, horizontal reverse (front/back conversion), rotation by an arbitrary angle, and the like with respect to a correlation of the image pickup element 31 set as a default with the display direction on the monitor screen of the liquid crystal monitor display 10.

In the display direction setter 34, for example, respective port numbers of the erected or inverted microscope are set via an operation input section 34a (attachment port input section). For the port numbers, for example, the respective ports 6a, 15a in the erected or inverted microscope are set to port “1”, the ports 6a, 15a to which the electronic camera main body is attached via the television adapter 8 are set to port “2”, the left-side port 17a in the inverted microscope is set to port “3”, the right-side port 17b in the inverted microscope is set to port “4”, and the front-surface port 17c in the inverted microscope is set to port “5”.

FIG. 11 is a diagram showing a configuration of the operation input section 34a. In the operation input section 34a, switches 34al, 34a2, 34a3, 34a4, 34a5 corresponding to the respective ports “1” to “5” are disposed for the observer to set the respective ports “1” to “5”.

The display direction setter 34 has a function as a display direction calculator for computing/processing the display direction of image data obtained by the image pickup element 31 in the liquid crystal monitor display 10 in accordance with the set port number.

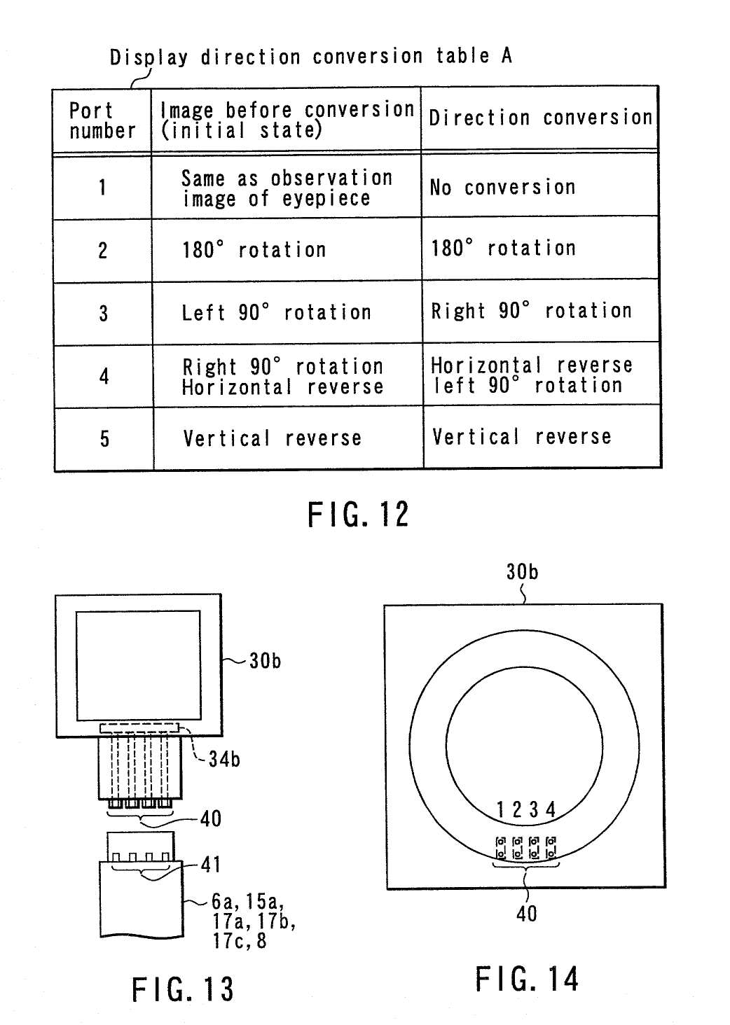

FIG. 12 shows a display direction conversion table owned by the display direction setter 34. A concrete display direction processing control in the display direction setter 34 is performed according to a display direction conversion table A shown in FIG. 12. The display direction setter 34 establishes settings so as to perform no display direction conversion processing with respect to the image data obtained by the image pickup element 31 when the port number is “1”, perform the display direction conversion processing for 180° rotation with respect to the image data obtained by the image pickup element 31 when the port number is “2”, perform the display direction conversion processing for right 90° rotation with respect to the image data obtained by the image pickup element 31 when the port number is “3”, perform the display direction conversion processing for horizontal reverse (front/back conversion) and left 90° rotation with respect to the image data obtained by the image pickup element 31 when the port number is “4”, and to perform the display direction conversion processing for vertical reverse, or {horizontal reverse (front/back conversion)+180° rotation} with respect to the image data obtained by the image pickup element 31 when the port number is “5”. The display direction setter 34 indicates such content of a display direction conversion calculation processing in accordance with the port number to the display direction controller 33.

The display direction controller 33 performs the display direction conversion processing with respect to the image data received from the image pickup element 31 via the preprocessor 32 in accordance with instructions from the display direction setter 34, and sends the converted/processed image data to the display processor 35. The display processor 35 receives the image data subjected to the display direction conversion processing by the display direction controller 33, performs a processing on the image data such that the data can be displayed in the liquid crystal monitor display 10, and sends the image data to the liquid crystal monitor display 10. In the display processor 35, an external output terminal 36 for sending the image data to external displays other than the liquid crystal monitor display 10 is disposed.

Moreover, the display direction controller 33 is connected to an image recorder 37. The image recorder 37 has a function of: receiving the image data from the display direction controller 33, that is, the image data having the same display direction as that of the image displayed in the liquid crystal monitor display 10 in accordance with the instruction from an image record instructor 38 disposed in the operation unit 9a; and recording the image data in a recording medium such as an image memory.

An operation of the electronic camera for the microscope configured as described above will next be described.

(1) When the electronic camera main body 30a is directly attached to the port 6a or 15a in the erected or inverted microscope, the observer operates the operation input section 34a to input the port number “1” in the display direction setter 34. The display direction setter 34 sets a processing method by the display direction controller 33 to “no conversion” in accordance with information on the port number “1” in the display direction conversion table A shown in FIG. 12.

On the other hand, the image pickup element 31 picks up an enlarged image of the sample 3 obtained by the observation optical system of the microscope main body 1 or 12, and outputs an image signal. The image signal is sent to the display direction controller 33 via the preprocessor 32.

The display direction controller 33 follows the setting of the display direction setter 34 to perform no display direction conversion processing on the image data obtained by the image pickup element 31, and sends the image data to the display processor 35. As a result, the image having the same display direction as that of the observation image observed via the eyepiece 16(7) is displayed in the monitor screen of the liquid crystal monitor display 10 as shown in FIG. 3.

In this state, when the observer inputs an image recording instruction to the image recorder 37 via the image record instructor 38 of the operation unit 9a, the image recorder 37 receives the image data from the display direction controller 33, that is, the image data having the same display direction as that of the image displayed in the liquid crystal monitor display 10, and records the image data in the recording mediums such as the image memory and a memory card.

(2) When the electronic camera main body 30a is attached to the port 6a or 15a in the erected or inverted microscope via the television adapter 8, the observer operates the operation input section to input the port number “2” in the display direction setter 34. The display direction setter 34 sets the processing method by the display direction controller 33 to “180° rotation” in accordance with information on the port number “2” in the display direction conversion table A shown in FIG. 12.

The display direction controller 33 follows the setting of the display direction setter 34 to perform the display direction conversion processing for rotating the image data obtained by the image pickup element 31 by 180°, and sends the image data to the display processor 35. As a result, the image having the same display direction as that of the observation image observed via the eyepiece 16(7) is displayed in the monitor screen of the liquid crystal monitor display 10 as shown in FIG. 3.

In this state, when the observer inputs the image recording instruction to the image recorder 37 via the image record instructor 38 of the operation unit 9a, the image recorder 37 receives the image data from the display direction controller 33, that is, the image data having the same display direction as that of the image displayed in the liquid crystal monitor display 10, and records the image data in the recording mediums such as the image memory and memory card.

(3) When the electronic camera main body 30a is attached to the left-side port 17a in the inverted microscope, the observer operates the operation input section to input the port number “3” in the display direction setter 34. The display direction setter 34 sets the processing method by the display direction controller 33 to “right 90° rotation” in accordance with information on the port number “3”, in the display direction conversion table A shown in FIG. 12.

The display direction controller 33 follows the setting of the display direction setter 34 to perform the display direction conversion processing for rotating the image data obtained by the image pickup element 31 by right 90°, and sends the image data to the display processor 35. As a result, the image having the same display direction as that of the observation image observed via the eyepiece 16 shown in FIG. 3 is displayed in the monitor screen of the liquid crystal monitor display 10.

In this state, when the observer inputs the image recording instruction to the image recorder 37 via the image record instructor 38 of the operation unit 9a, the image recorder 37 receives the image data from the display direction controller 33, that is, the image data having the same display direction as that of the image displayed in the liquid crystal monitor display 10, and records the image data in the recording mediums such as the image memory and memory card.

(4) When the electronic camera main body 30a is attached to the right-side port 17b in the inverted microscope, the observer operates the operation input section to input the port number “4” in the display direction setter 34. The display direction setter 34 sets the processing method by the display direction controller 33 to “horizontal reverse+left 90° rotation” in accordance with information on the port number “4” in the display direction conversion table A shown in FIG. 12.

The display direction controller 33 follows the setting of the display direction setter 34 to perform the conversion processing for subjecting the image data obtained by the image pickup element 31 to the horizontal reverse (front/back conversion) and left 90° rotation, and sends the image data to the display processor 35. As a result, the image having the same display direction as that of the observation image observed via the eyepiece 16 shown in FIG. 3 is displayed in the monitor screen of the liquid crystal monitor display 10.

In this state, when the observer inputs the image recording instruction to the image recorder 37 via the image record instructor 38 of the operation unit 9a, the image recorder 37 receives the image data from the display direction controller 33, that is, the image data having the same display direction as that of the image displayed in the liquid crystal monitor display 10, and records the image data in the recording mediums such as the image memory and memory card.

(5) When the electronic camera main body 30a is attached to the front-surface port 17c in the inverted microscope, the observer operates the operation input section to input the port number “5” in the display direction setter 34. The display direction setter 34 sets the processing method by the display direction controller 33 to “vertical reverse” (“horizontal reverse+180° rotation”) in accordance with information on the port number “5” in the display direction conversion table A shown in FIG. 12.

The display direction controller 33 follows the setting of the display direction setter 34 to perform the display direction conversion processing for subjecting the image data obtained by the image pickup element 31 to vertical reverse (“horizontal reverse (front/back conversion)+180° rotation”), and sends the image data to the display processor 35. As a result, the image having the same display direction as that of the observation image observed via the eyepiece 16 shown in FIG. 14 is displayed in the monitor screen of the liquid crystal monitor display 10.

In this state, when the observer inputs the image recording instruction to the image recorder 37 via the image record instructor 38 of the operation unit 9a, the image recorder 37 receives the image data from the display direction controller 33, that is, the image data having the same display direction as that of the image displayed in the liquid crystal monitor display 10, and records the image data in the recording mediums such as the image memory and memory card.

As described above, according to the first embodiment, when the electronic camera main body 30a is attached to the respective ports 6a, 15a in the erected or inverted microscope, attached via the television adapter 8, or attached to the respective ports 17a to 17c in the inverted microscope, the conversion processing is performed in accordance with these ports to subject the image data obtained by the image pickup element 31 to rotation, vertical reverse (“horizontal reverse (front/back conversion)+180° rotation”), or horizontal reverse (front/back conversion) in the display direction controller 33, and the image data is sent to the display processor 35. Therefore, even when the electronic camera main body 30a of the electronic camera for the microscope is attached to any one of the ports 6a, 15a, 17a to 17c, the image having the same display direction as that of the observation image observed via the eyepiece 16 shown in FIG. 3 by the observer can be displayed in the monitor screen of the liquid crystal monitor display 10. Therefore, it becomes easy to frame or focus the image on the monitor screen of the liquid crystal monitor display 10, for example, during photography.

Moreover, when the rotation angle of the conversion processing is changed with respect to the image data regarding the respective port numbers “1” to “5” stored in the display direction conversion table A, the observer can display the image at a desired rotation angle in the monitor display. Furthermore, the image data having the same display direction as that of the image to be displayed in the liquid crystal monitor display 10 can be recorded in the recording mediums such as the image memory and memory card by the image recorder 37.

FIG. 22 is a diagram showing a configuration of an operation input section 34a′ as the modification example of the operation input section 34a. In the electronic camera for the microscope, the operation input section 34a′ which can directly designate the image display direction may be used instead of the operation input section 34a. In the operation input section 34a′, switches 34a1′, 34a2′, 34a3′, 34a4′, 34a5′ for the observer to directly set the display direction of the observation image are disposed. In this case, the display direction setter 34 outputs the display direction inputted via the switch in the operation input section 34a′ as it is to the display direction controller 33.

The first embodiment may be modified as follows.

(1) In the first embodiment, as shown in the display direction conversion table A of FIG. 12, the image conversion processing directions are set with respect to the respective ports “1” to “5”, but the present invention is not limited to this, and the display direction conversion table A may arbitrarily be varied so as to rotate/process the image by a desired angle in a direction desired by the observer.

(2) In the first embodiment, the operation input section is operated to input the port number to the display direction setter 34, but as shown in FIG. 13, an electronic camera main body 30b, respective ports 6a, 15a, 17a to 17c or television adapter 8 may be provided with respective contact electrodes 40, 41 for setting the respective display directions (camera-side electrode, port-side electrode as attachment port recognizing section), and the electronic camera main body 30 may be provided with a function of judging the port to which the main body is attached.

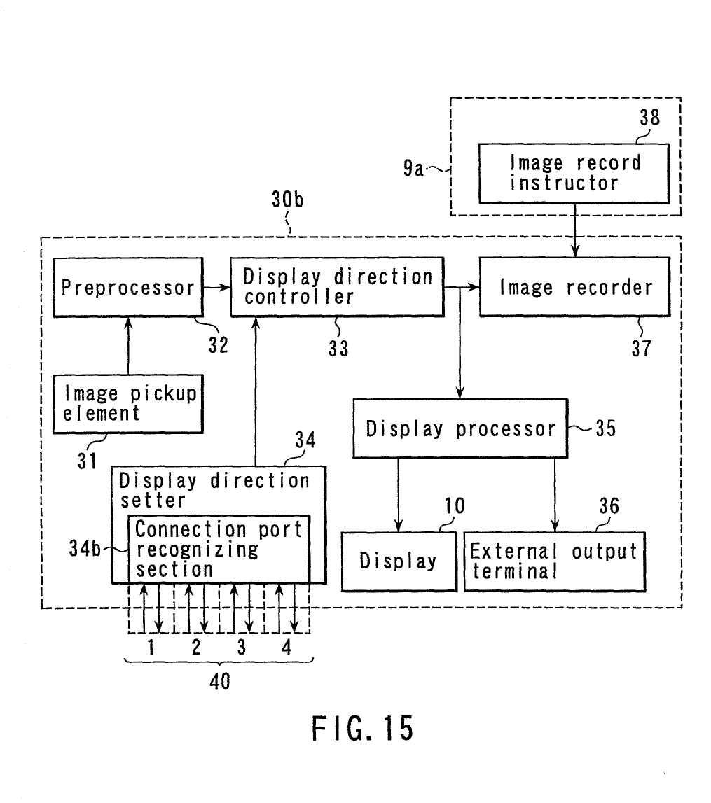

FIG. 14 is a diagram showing a camera-side electrode of the display direction setter 34 according to the modification example, and FIG. 15 is a block diagram showing a configuration of the electronic camera for the microscope according to the modification example. As shown in FIGS. 14 and 15, camera-side electrodes 40 consisting of four electrodes (contact switches) are disposed in the electronic camera main body 30b. Here, the respective electrodes of the camera-side electrodes 40 are denoted with “1”, “2”, “3”, “4”. These electrodes are connected to a connection port recognizing section 34b.

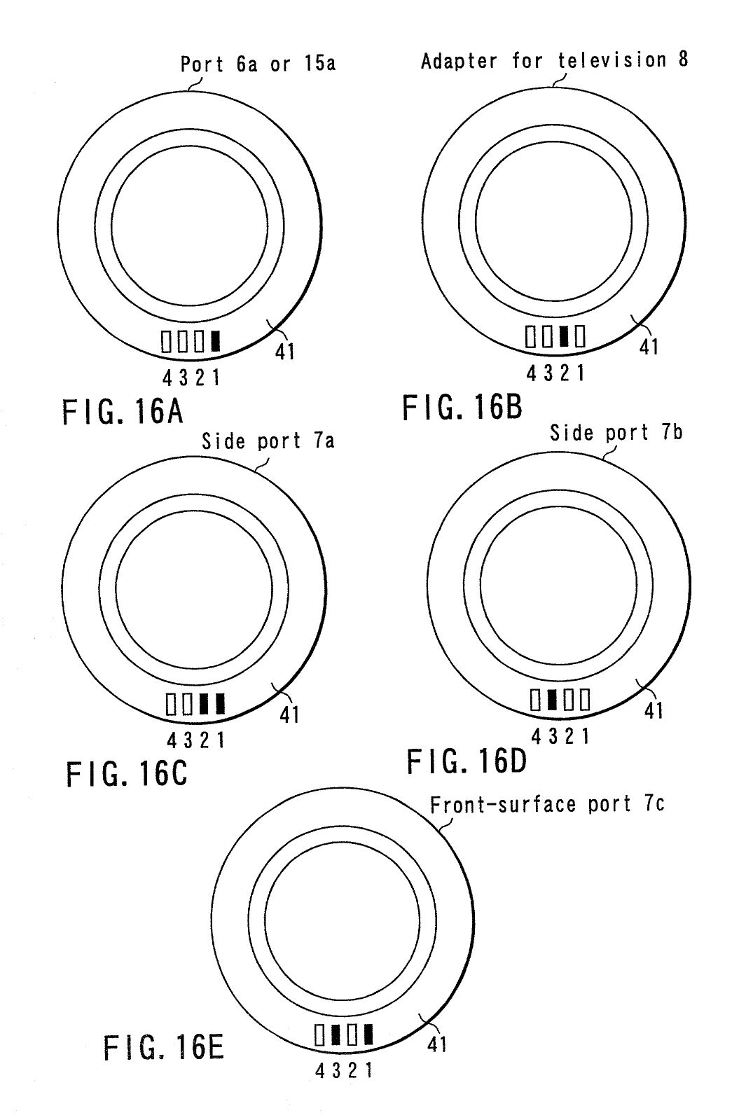

On the other hand, as shown in FIG. 16A, a port-side electrode 41 is disposed in a position corresponding to the electrode “1” of the camera-side electrodes 40 in the port 6a or 15a in the erected or inverted microscope. Moreover, as shown in FIG. 16B, the port-side electrode 41 is disposed in a position corresponding to the electrode “2” of the camera-side electrodes 40 in the television adapter 8. Furthermore, as shown in FIG. 16C, the port-side electrodes 41 are disposed in the positions corresponding to the electrodes “1” and “2” of the camera-side electrodes 40 in the left-side port 7a. As shown in FIG. 16D, the port-side electrode 41 is disposed in a position corresponding to the electrode “3” of the camera-side electrodes 40 in the right-side port 7b. As shown in FIG. 16E, the port-side electrodes 41 are disposed in the positions corresponding to the electrodes “1” and “3” of the camera-side electrodes 40 in the front-surface port 7c.

When the electronic camera main body 30b is attached to the respective ports 6a, 15a, 17a to 17c or the television adapter 8 in this manner, the camera-side electrode 40 electrically contacts the port-side electrode 41, and corresponding electric signals are generated in the respective ports 6a, 15a, 17a to 17c or the television adapter 8 to which the electronic camera main body 30b is attached.

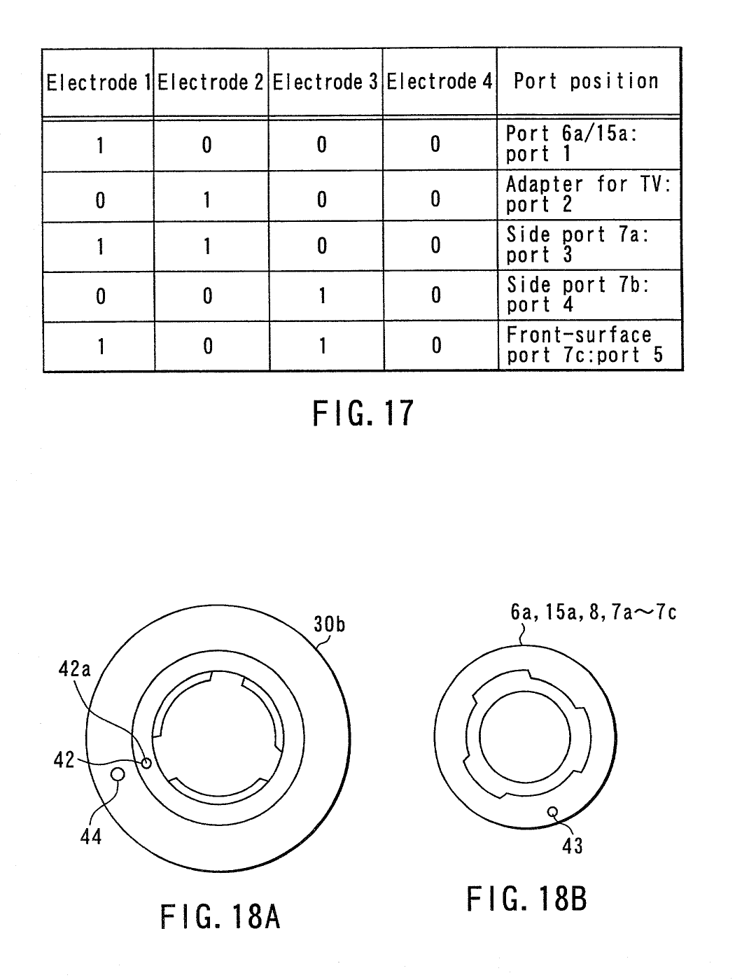

Thereby, the connection port recognizing section 34b extracts the electric signal generated by the electric contact of the camera-side electrode 40 with the port-side electrode 41. Furthermore, the connection port recognizing section 34b has a table shown in FIG. 17, and refers to the table to recognize/set the port number in response to the extracted electric signal. The display direction setter 34 reads the processing method of the display direction corresponding to the port number from the display direction conversion table A shown in FIG. 12, and sets the processing method in the display direction controller 33. The display direction controller 33 follows the setting of the display direction setter 34, and performs the conversion processing with respect to the image data obtained by the image pickup element 31.

Additionally, the camera-side electrode 40 of the electronic camera main body 30 and the port-side electrode 41 in the respective ports 6a, 15a, 17a to 17c and television adapter 8 are positioned as follows.

As shown in FIG. 18A, a hole 42 is formed in a mount of the electronic camera main body 30b. A positioning pin 42a which is urged by a spring and cooperates with a release button 44 to freely go into/out of the hole is disposed in the hole 42. Moreover, as shown in FIG. 18B, a positioning hole 43 is formed in the mount of the respective ports 6a, 15a, 17a to 17c or the television adapter 8.

When the electronic camera main body 30b is attached to the respective ports 6a, 15a, 17a to 17c or the television adapter 8, and the positioning pin 42a is aligned with the hole 43 in the respective mounts, the pin 42a is inserted into the hole 43, and the electronic camera main body 30 is fixed to the respective ports 6a, 15a, 17a to 17c or the television adapter 8. Additionally, a positioning mechanism by the pin 42a and hole 43 may be omitted.

(3) A sensor may be disposed in a port connection portion of the electronic camera main body 30b. In this case, targets are disposed in order to generate different signals in the respective ports 6a, 15a, 17a to 17c or the television adapter 8 with respect to the sensor, the display direction setter 34 inputs the signal generated by the target and detected by the sensor, and the port with the electronic camera main body 30b attached thereto is judged.

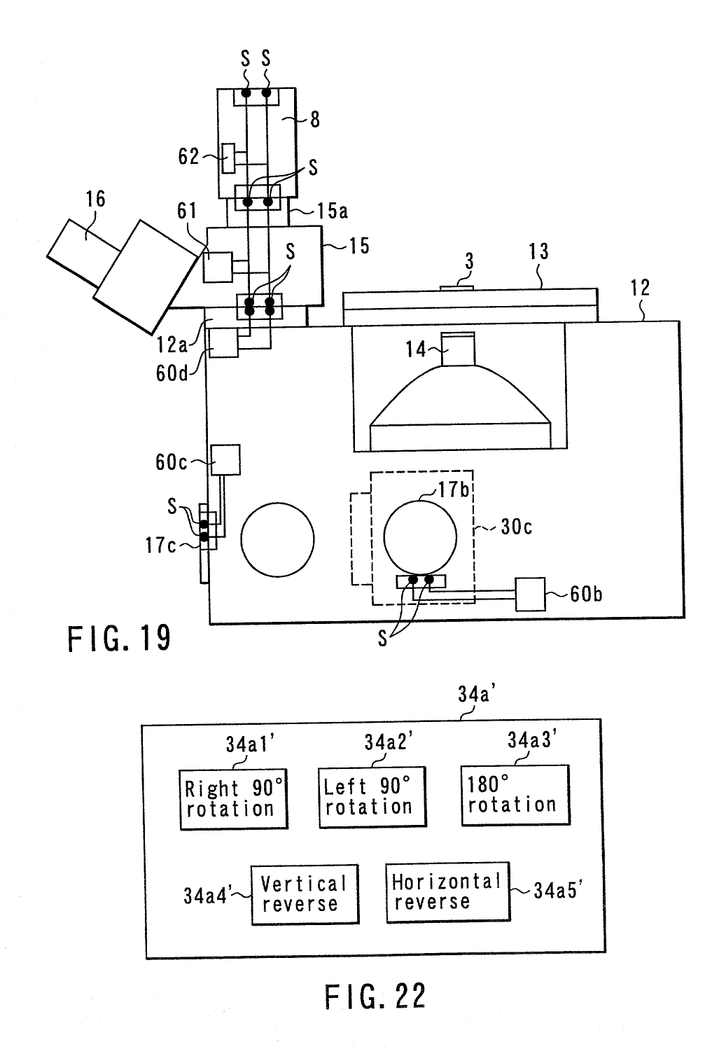

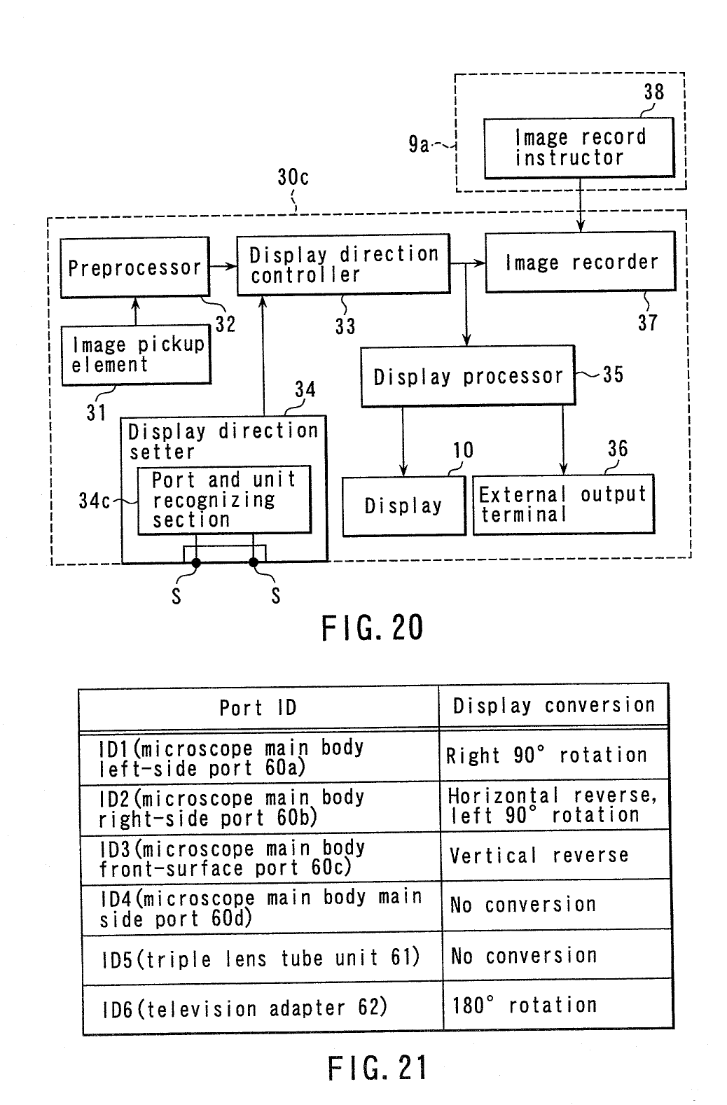

FIG. 19 is a side view showing the entire configuration in which the electronic camera for the microscope according to the second embodiment of the present invention (digital camera) is attached to the inverted microscope, and FIG. 20 is a block diagram showing the configuration of the electronic camera for the microscope. In FIGS. 19 and 20, the same components as those of FIGS. 9A and 10 are denoted with the same reference numerals, and detailed description thereof is omitted.

First, the configuration of the microscope and electronic camera for the microscope of the second embodiment will first be described. Four connection ports 17a (not shown), 17b, 17c, 12a are disposed in the inverted microscope main body 12, and an electronic camera main body 30c is attached to the right-side port 17b. The electronic camera main body 30c can be attached to the port 12a of the inverted microscope via the port 15a of a triple lens tube unit 15. Moreover, the television adapter 8 is attached to the port 15a, and the electronic camera main body 30c can also be attached to the television adapter 8. Furthermore, the electronic camera main body 30c can also be attached to the left-side port 17a or the front-surface port 17c of the inverted microscope.

Port ID storage sections 60a (not shown), 60b, 60c, 60d, 61, 62 each formed of a memory or the like are disposed in the respective connection ports 17a, 17b, 17c, 12a, triple lens tube unit 15, and television adapter 8. In the respective port ID storage sections 60a to 60d, 61, 62, IDs of the corresponding ports 17a, 17b, 17c, 12a, triple lens tube unit 15, and television adapter 8 are stored as “ID1”, “ID2”, “ID3”, “ID4”, “ID5”, “ID6”.

These port ID storage sections 60a to 60d, 61, 62 are connected to a port and unit recognizing section 34c of the electronic camera main body 30c directly or via a configuration unit. The connection is realized via a contact S. The port and unit recognizing section 34c is connected to the display direction setter 34. In the port and unit recognizing section 34c of the electronic camera main body 30c, a table showing display conversion forms of the port connected to the electronic camera 30 and configuration unit IDs is stored as shown in FIG. 21. Since other configuration s of the electronic camera are similar to those of the first embodiment, description thereof is omitted.

An operation of the microscope and electronic camera configured as described above will next be described. When the electronic camera main body 30c is attached to the right-side port 17b of the microscope main body 12, the port and unit recognizing section 34c of the electronic camera main body 30c is connected to the port ID storage section 60b. Therefore, when the port ID stored in the section is read, it is recognized that the electronic camera main body 30c is attached to the right-side port 17b. Thereby, the port and unit recognizing section 34c of the electronic camera main body 30c refers to the table of FIG. 21, and sets the display direction controller 33 via the display direction setter 34, so that the display conversion form is “horizontal reverse, left 90° rotation” corresponding to the port ID “ID2”.

Moreover, when the electronic camera main body 30c is attached to the television adapter 8, the port and unit recognizing section 34c of the electronic camera main body 30c is connected to the port ID storage sections 60d, 61, 62. It is recognized that the port 12a, triple lens tube unit 15, and television adapter 8 are connected. Therefore, the port and unit recognizing section 34c of the electronic camera main body 30c refers to the table of FIG. 21, and sets the operation to the display direction controller 33 via the display direction setter 34, so that the display conversion form is “no conversion”+“no conversion”+“180° rotation” corresponding to the port IDs “ID4”, “ID5”, “ID6” in order to cancel an optical action of each unit. Since other operations of the electronic camera are similar to those of the first embodiment, description thereof is omitted.

As described above, according to the second embodiment, in addition to the effect of the first embodiment, even when various configuration units are connected to the port of the microscope, the electronic camera automatically recognizes the configured unit, and the display direction can be converted in order to cancel optical actions of the respective units. Therefore, even with any microscope configuration, the observer can constantly observe the image having the same display direction as that of the image observed via the eyepiece without especially considering the microscope configuration.

As described above in detail, according to the present invention, there can be provided the electronic camera for the microscope which can display the observation image in the display direction necessary for the observer even when attached to any one of the respective ports different in image direction from one another.

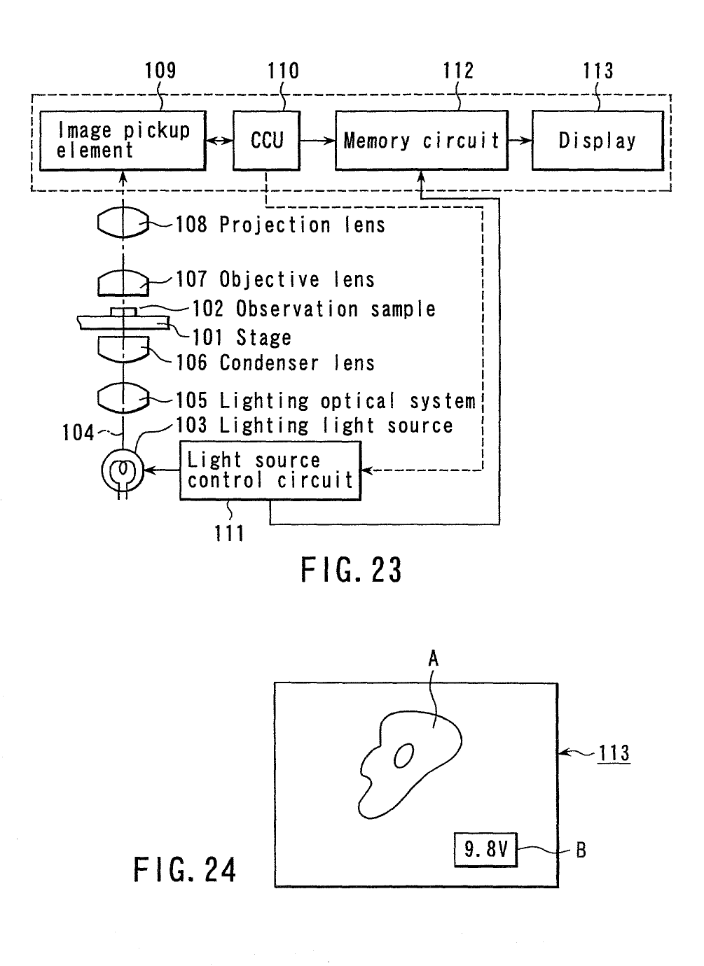

FIG. 23 is a diagram showing a configuration of a microscope system according to a third embodiment of the present invention. In FIG. 23, an observation sample 102 is laid on a stage 101. A lighting light source 103 of a halogen lamp, a mercury light, or the like is disposed under the stage 101. A lighting optical system 105 and condenser lens 106 are disposed between the lighting light source 103 and the stage 101 in a lighting path 104. The observation sample 102 is irradiated with a lighting light from the lighting light source 103 as a transmitting light from below the stage 101 via the lighting optical system 105 and condenser lens 106.

An objective lens 107 is disposed opposite to the observation sample 102 above the stage 101. The observation image from the objective lens 107 is formed on an image pickup surface of an image pickup element 109 of CCD or the like via a projection lens (eyepiece) 108. The image pickup element 109 is connected to a camera control unit (hereinafter abbreviated as CCU) 110. Moreover, the CCU 110 is connected to a monitor display 113 via a memory circuit 112.

The CCU 110 sets image pickup conditions such as exposure (AE), exposure time, and gain with respect to the image pickup element 109, and adjusts color balance, gradation characteristics, and the like of the observation image picked up by the image pickup element 109. A light source control circuit 111 adjusts a light amount of the lighting light source 103. In the memory circuit 112, the observation image adjusted in the CCU 110 and a state of light amount adjustment by the light source control circuit 111 are recorded, and these are displayed in the display 113 in a superposed manner.

An operation of the microscope system configured as described above will next be described. When the observer lays the observation sample 102 on the stage 101, and turns on the lighting light source 103, the observation sample 102 is irradiated with the lighting light from the lighting light source 103 as a transmission light from below the stage 101 via the lighting optical system 105 and condenser lens 106. When the transmission light passes through the observation sample 102, the observation image obtained via the objective lens 107 is picked up by the image pickup element 109 via the projection lens (eyepiece) 108. The image is adjusted in the CCU 110, and subsequently stored in the memory circuit 112. The light source control circuit 111 sends and stores the state of the light amount adjustment as state information to the memory circuit 112.

Thereby, the observation image of the observation sample 102 stored in the memory circuit 112 is superposed and displayed as the light amount adjustment content of the light source control circuit 111 on the display screen of the display 113.

FIG. 24 is a diagram showing a display example in the display 113. On the display screen of the display 113, an observation image A of the observation sample 102 is superposed and displayed with, for example, a voltage value B supplied to the lighting light source 103 as the light amount adjustment amount to the lighting light source 103 by the light source control circuit 111. Additionally, as a display form of state information of the light amount adjustment, for example, the voltage value may be replaced with a bar graph, so that the bar graph is displayed.

As described above, according to the third embodiment, on the display screen of the display 113, the observation image picked up the image pickup element 109 and transmitted via the objective lens 107 is superposed and displayed with the state of the light amount adjustment for the lighting light source 103 by the light source control circuit 111. Therefore, the observer grasps the information of the light amount adjustment on the display screen, and can use the content to adjust the light amount of the lighting light source 103. Thereby, the sample can be observed under stable observation conditions without being influenced by observer's sense or experience.

Moreover, an example in which the observer manually adjusts the light amount of the lighting light source has been described above, but the lighting light amount may automatically be controlled. In this configuration, the CCU 110 is connected to the light source control circuit 111 as shown by a broken line of FIG. 23, and a set content of image pickup conditions of the image pickup element 109 is transmitted to the light source control circuit 111 from the CCU 110. The light source control circuit 111 has a function of automatically adjusting the light amount of the lighting light source 103 in accordance with the received content of the image pickup conditions. Moreover, the state of the light amount adjustment is transmitted and stored as the state information of the light source to the memory circuit 112 via the light source control circuit 111. On the display screen of the display 113, together with the sample observation image, the state of the lighting light amount obtained by the light source control circuit 111 is superposed and displayed.

In this case, since the light amount of the lighting light source 103 is automatically adjusted in accordance with the set content of the image pickup conditions for the image pickup element 109, a clear observation image with a good S/N ratio can be obtained. Moreover, since the light amount of the lighting light source 103 can remarkably be reduced, for example, by raising a gain for the image pickup element 109, even the operation with a low power consumption is possible.

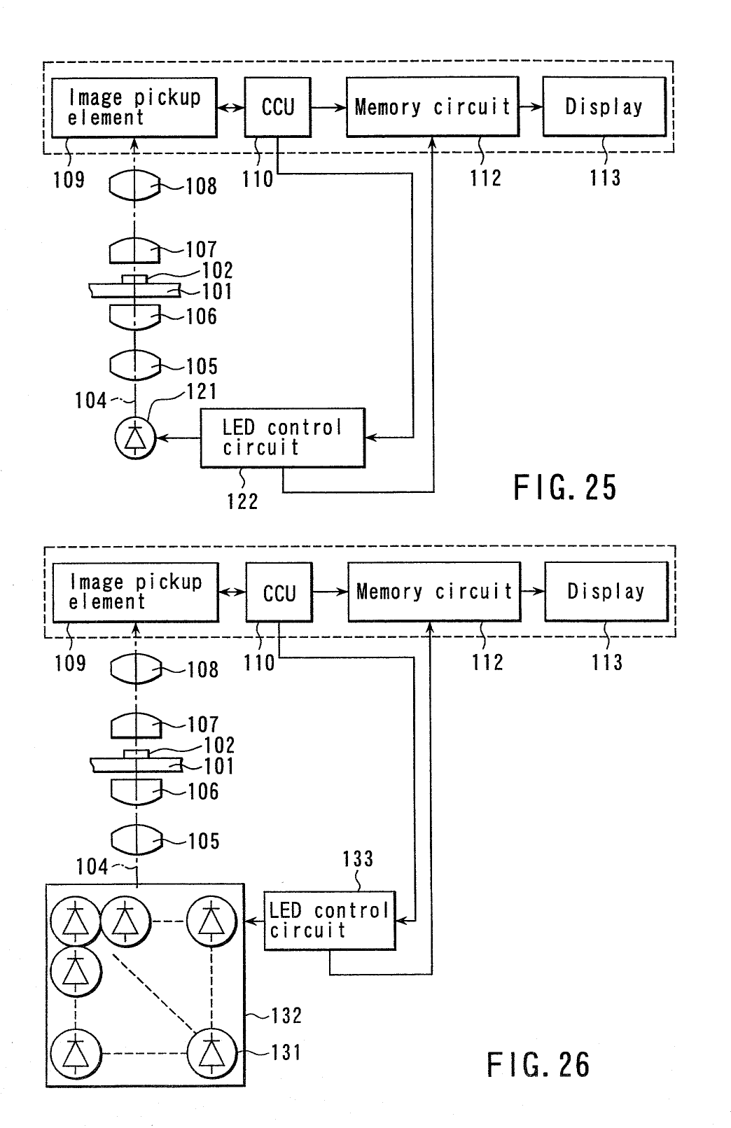

FIG. 25 is a diagram showing the configuration of the microscope system according to a fourth embodiment of the present invention. In FIG. 25, the same components as those of FIG. 23 are denoted with the same reference numerals. In this configuration, LED 121 is used as a lighting light source, and the light amount of the LED 121 is automatically adjusted by a light source control circuit 122.

Even in this configuration, together with the observation image, the state information of the light amount adjustment for the LED 121 can be superposed and displayed on the display screen of the display 113. Therefore, the effect can similarly be obtained. Moreover, since the LED 121 is used in the lighting light source, the configuration of the light source control circuit 122 can be simplified, a current to be supplied to the lighting light source is reduced, power consumption can be lowered, and the system can inexpensively be configured.

FIG. 26 is a diagram showing the configuration of the microscope system according to a fifth embodiment of the present invention. In FIG. 26, the same components as those of FIG. 25 are denoted with the same reference numerals. In this configuration, an LED light source 132 including a plurality of LEDs 131 is used as the lighting light source, and the LED 131 of the LED light source 132 is selected by an LED control circuit 133.

Even in this configuration, together with the observation image, a selection state of the LED 131 of the LED light source 132 can be superposed and displayed on the display screen of the display 113. Therefore, the effect can similarly be obtained. Moreover, since the LED 131 for use can be selected by the LED control circuit 133, the optimum lighting conditions can be set for each observation sample 102, and the sample can be observed in more satisfactory observation conditions. Furthermore, since a plurality of LEDs 131 are used, the amount of irradiation light of the observation sample 102 increases. Since the amount of the light incident upon the image pickup element 109 increases, the image with a good S/N ratio can be obtained.

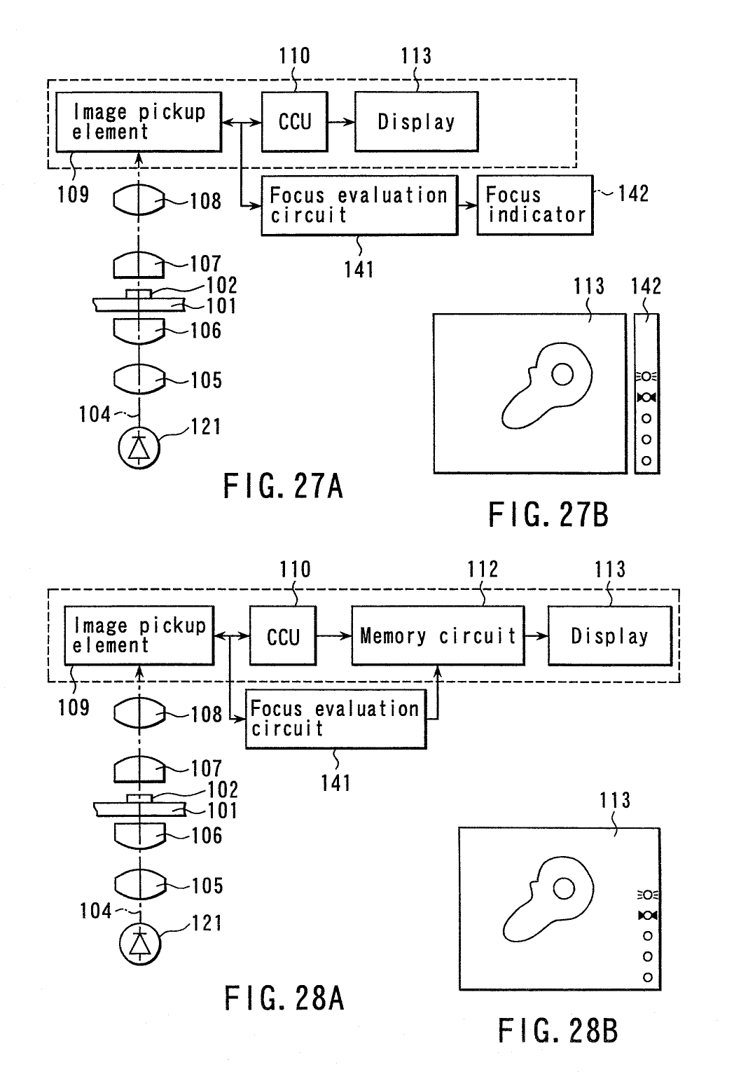

FIGS. 27A and 27B are diagrams showing the configuration of the microscope system according to a sixth embodiment of the present invention. In FIGS. 27A and 27B, the same components as those of FIG. 25 are denoted with the same reference numerals.

In this configuration, the image pickup element 109 is connected to a focus evaluation circuit 141, and the focus evaluation circuit 141 is connected to a focus indicator 142. The focus evaluation circuit 141 calculates a contrast of the image picked up by the image pickup element 109, detects the present focus state, and displays the result as operation information in the focus indicator 142. For example, as shown in FIG. 27B, the focus indicator 142 is arranged besides the display 113, and the focus state can be distinguished at a glance.

In this configuration, the observation image is displayed on the display screen of the display 113, the focus state is successively displayed in the focus indicator 142, and the observer can grasp the present focus state via the focus indicator 142 while observing the sample. Quick focusing is possible, and efficient sample observation can be realized.

FIGS. 28A and 28B are diagrams showing the configuration of the microscope system according to a seventh embodiment of the present invention. In FIGS. 28A and 28B, the same components as those of FIGS. 27A and 27B are denoted with the same reference numerals.

In this configuration, a result of contrast calculation of the pickup image executed in the focus evaluation circuit 141 is stored as operation information in the memory circuit 112, and superposed and displayed with the observation image of the observation sample 102 stored in the memory circuit 112 on the display screen of the display 113. That is, the focus indicator is displayed with the observation image in the display 113, for example, as shown in FIG. 28B.

Since the contrast calculation result in the focus evaluation circuit 141 is superposed and displayed with the observation image on the display screen of the display 113, the configuration is more advantageous in respect of visibility and operability during sample observation. Moreover, since the focus indicator can be omitted, the system configuration is also simplified.

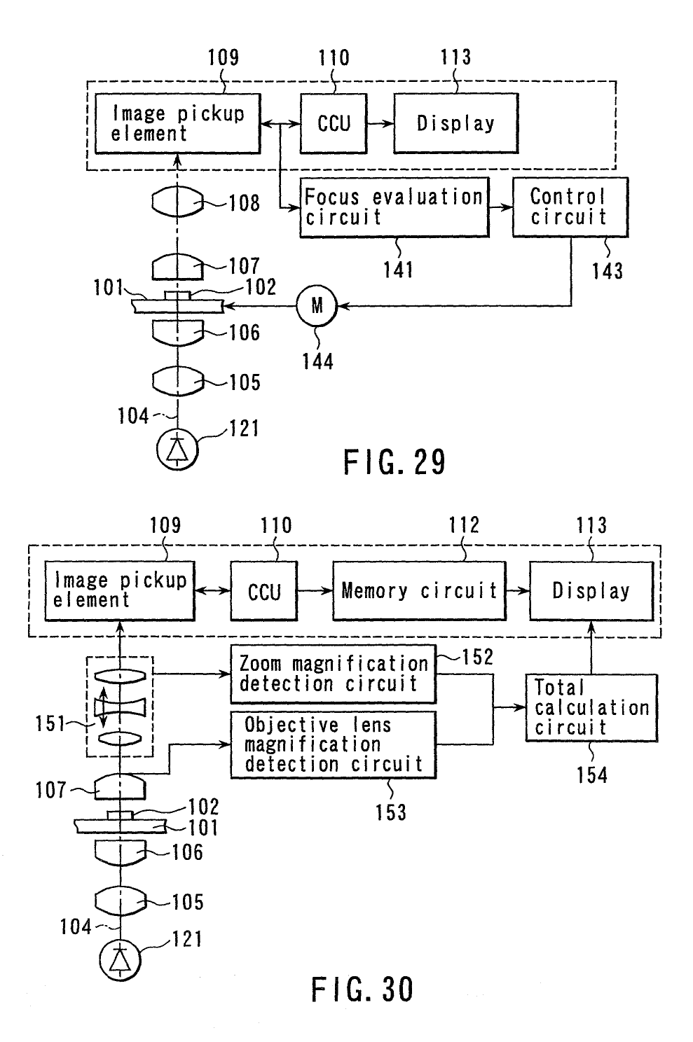

FIG. 29 is a diagram showing the configuration of the microscope system according to an eighth embodiment of the present invention. In FIG. 29, the same components as those of FIG. 27A are denoted with the same reference numerals.

In this configuration, the focus evaluation circuit 141 is connected to a control circuit 143, and the control circuit 143 is connected to a stage driving motor 144. When the contrast calculation result of the pickup image obtained by the focus evaluation circuit 141 is inputted, the control circuit 143 controls the stage driving motor 144 in accordance with the result to move the stage 101 to the focus position.

In this configuration, since the focusing operation for the observation sample 102 can automatically be performed, the operability can be enhanced during the sample observation.

FIG. 30 is a diagram showing the configuration of the microscope system according to a ninth embodiment of the present invention. In FIG. 30, the same components as those of FIG. 25 are denoted with the same reference numerals.

In this configuration, a projection zoom lens 151 is inserted between the objective lens 107 and the image pickup element 109, and a magnification of the observation image picked up by the image pickup element 109 can be adjusted/varied. Moreover, the projection zoom lens 151 is connected to a zoom magnification detection circuit 152, and the objective lens 107 (revolver) is connected to an objective lens magnification detection circuit 153. The zoom magnification detection circuit 152 and objective lens magnification detection circuit 153 are connected to a total calculation circuit 154. The total calculation circuit 154 is connected to the memory circuit 112.

The zoom magnification detection circuit 152 detects a zoom magnification of the projection zoom lens 151, and the objective lens magnification detection circuit 153 detects the magnification of the objective lens 107 inserted to an observation optical axis. Moreover, the total calculation circuit 154 calculates the projection magnification in the observation optical system from the magnifications detected by the zoom magnification detection circuit 152 and objective lens magnification detection circuit 153. Information regarding the magnifications is stored as set information in the memory circuit 112, and superposed and displayed with the observation image of the observation sample 102 stored in the memory circuit 112 on the display screen of the display 113.

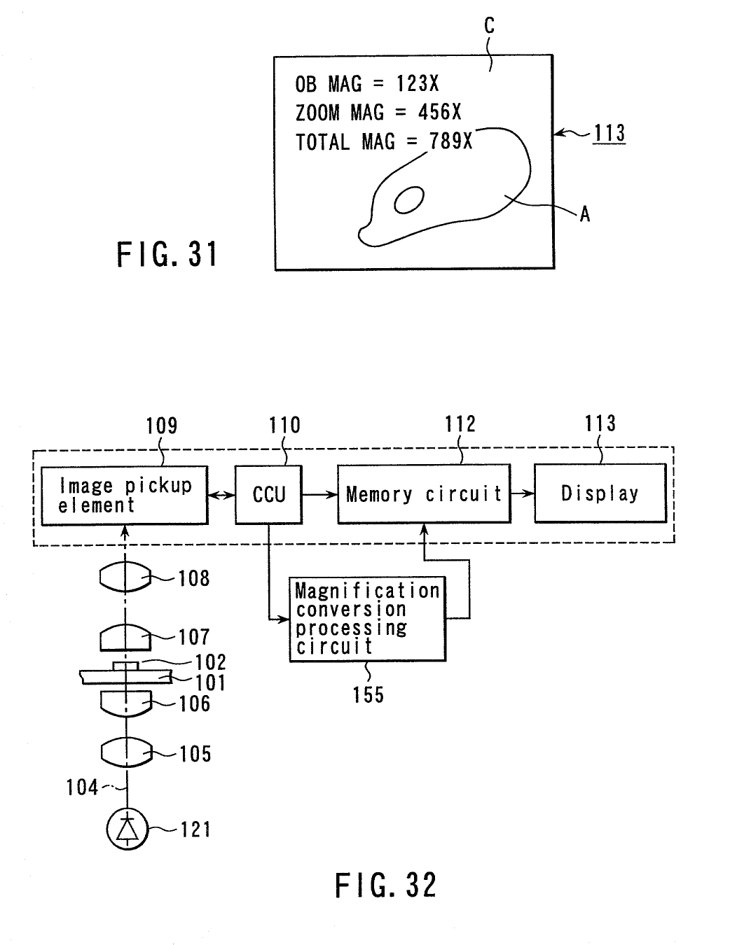

FIG. 31 is a diagram showing the display example in the display 113. Magnification information C such as the zoom magnification of the projection zoom lens 151, the magnification of the objective lens 107, and the projection magnification of the observation optical system calculated by the total calculation circuit 154 are superposed and displayed with the observation image A of the observation sample 102 on the display screen of the display 113.

In this configuration, since the magnification information C is displayed with the observation image on the display screen of the display 113, the observer can use the magnification information C as a standard to observe the sample, and the sample can be observed under observation conditions without being influenced by the observer's sense or experience.

Additionally, the example in which the projection zoom lens 151 is disposed has been described above, but a zoom objective lens may be used instead of the objective lens 107.

FIG. 32 is a diagram showing the configuration of the microscope system according to a tenth embodiment of the present invention. In FIG. 32, the same components as those of FIG. 25 are denoted with the same reference numerals.

In this configuration, the CPU 110 has a function of setting the image pickup conditions for the image pickup element 109, and adjusting the observation image picked up by the image pickup element 109, and further has an electronic zoom function for enlarging or reducing the picked up observation image by an image processing. Moreover, the electronic zoom magnification in the CCU 110 is obtained by a magnification conversion processing circuit 155, and the processing result is stored as the set information in the memory circuit 112, and superposed and displayed with the observation image of the observation sample 102 recorded in the memory circuit 112 on the display screen of the display 113.

Even in this configuration, the observation image is displayed with the magnification information in the display screen of the display 113, the observer can use the magnification information as the standard to observe the sample, and the sample can be observed under stable observation conditions.

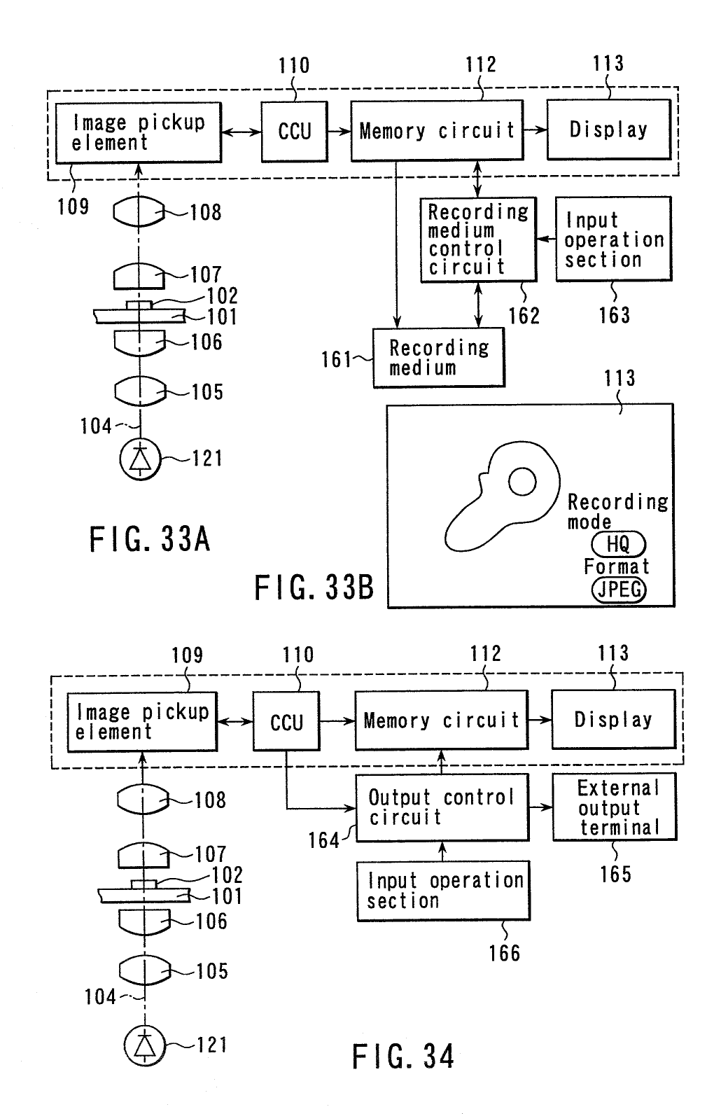

FIGS. 33A and 33B are diagrams showing the configuration of the microscope system according to an eleventh embodiment of the present invention. In FIGS. 33A, 33B, the same components as those of FIG. 25 are denoted with the same reference numerals.

In this configuration, the memory circuit 112 is connected to a recording medium 161 such as smart media and compact flash. Moreover, the memory circuit 112 and recording medium 161 are connected to a recording medium control circuit 162. The recording medium control circuit 162 is connected to an input operation section 163, and writing of a content stored in the memory circuit 112 to the recording medium 161 and reading of the content stored in the recording medium 161 to the memory circuit 112 are controlled by the operation of the input operation section 163.

Moreover, operation information in the input operation section 163 and read/write information for the recording medium 161 are stored as the operation information in the memory circuit 112, and superposed and displayed with the observation image of the observation sample 2 stored in the memory circuit 112 on the display screen of the display 13. That is, for example, as shown in FIG. 33B, image format display types such as JPEG and TIFF and image recording mode types such as SQ, HQ and SHQ modes are displayed as a set state of image recording with the observation image on the display screen of the display 113. Additionally, the image recording mode determines a compression ratio during recording. The SQ mode sets a highest compression ratio, and the compression ratio decreases in order of HQ and SHQ.

In this configuration, the observer can operate the input operation section 163 to freely move the content stored in the memory circuit 112 to the recording medium 161, and move the content recorded in the recording medium 161 to the memory circuit 112. Moreover, the operation content information in the input operation section 163, read/write state in the recording medium 161, and the like are displayed with the observation image on the display screen of the display 113. Therefore, the observer can confirm the information while observing the sample. Satisfactory sample observation is possible.

FIG. 34 is a diagram showing the configuration of the microscope system according to a twelfth embodiment of the present invention. In FIG. 34, the same components as those of FIG. 25 are denoted with the same reference numerals.

In the configuration, the CCU 110 is connected to an output control circuit 164. The output control circuit 164 is connected to an external output terminal 165 and input operation section 166. By operation in the input operation section 166, information stored in the memory circuit 112, such as the image pickup conditions in the CCU 110 for the image pickup element 109 and the image adjustment conditions of the observation image are outputted to the external output terminal 165 via the output control circuit 164. Furthermore, the operation information in the input operation section 166 and information outputted via the external output terminal 165 are superposed and displayed as the operation information with the observation image of the observation sample 102 stored in the memory circuit 112 on the display screen of the display 113.

In this configuration, the observer can operate the input operation section 166 to extract the information such as the image pickup conditions in the CCU 110 and image adjustment conditions to the outside via the external output terminal 165. Moreover, the operation information in the input operation section 166 and the information outputted via the external output terminal 165 are displayed with the observation image on the display screen of the display 113. Therefore, the observer can confirm these information while satisfactorily observing the sample.

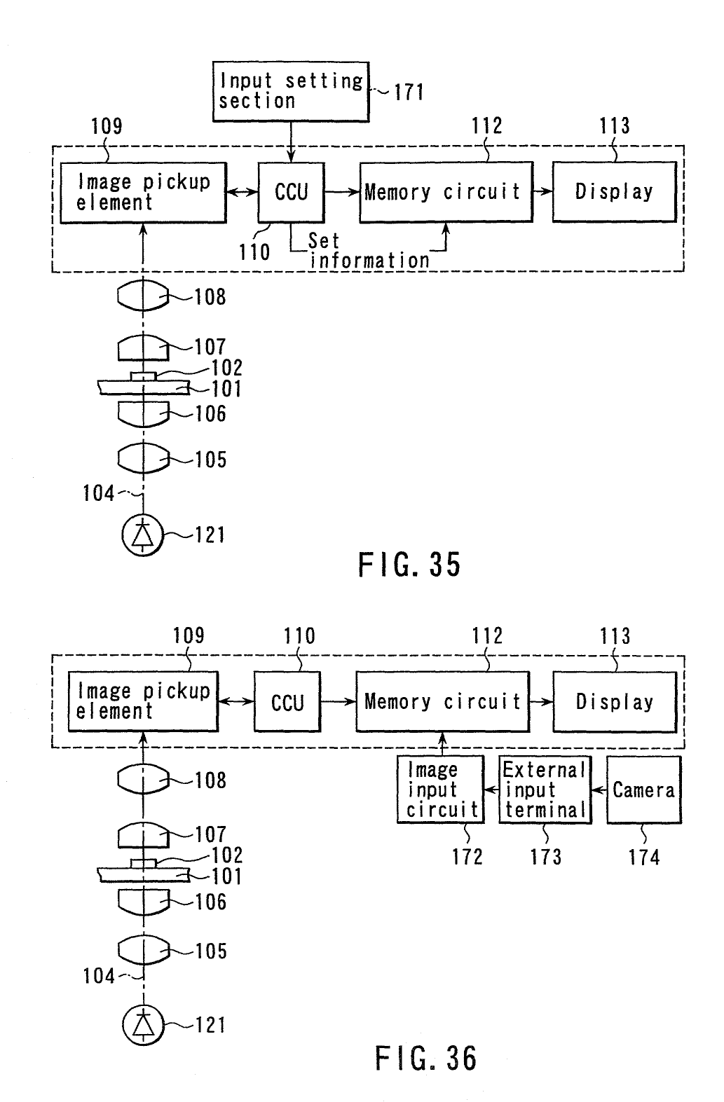

FIG. 35 is a diagram showing the configuration of the microscope system according to a thirteenth embodiment of the present invention. In FIG. 35 the same components as those of FIG. 25 are denoted with the same reference numerals.

In this configuration, the CCU 110 is connected to an input setting section 171. The input setting section 171 sets image pickup conditions in the CCU 110 for the image pickup element 109, such as automatic exposure (AE), exposure time and gain, and image adjustment conditions for the observation image, such as color balance and gradation characteristics. Moreover, the information such as the image pickup conditions and image adjustment conditions are inputted as the set information to the memory circuit 112 by the CCU 110, and are superposed and displayed with the observation image of the observation sample 102 stored in the memory circuit 112 on the display screen of the display 113.

In this configuration, the observer can operate the input setting section 171 to freely set the image pickup conditions for the image pickup element 109 and the image adjustment conditions for the observation image in the CCU 110. Moreover, the information set by the input setting section 171 is displayed with the observation image on the display screen of the display 113. Therefore, the observer can confirm the information while satisfactorily observing the sample.

FIG. 36 is a diagram showing the configuration of the microscope system according to a fourteenth embodiment of the present invention. In FIG. 36 the same components as those of FIG. 25 are denoted with the same reference numerals.

In this configuration, the memory circuit 112 is connected to an image input circuit 172, and the image input circuit 172 is connected to an external input terminal 173. The external input terminal 173 is connected to a camera 174.

In this configuration, the camera 174 uses a silver salt film for photographing the observation image via the objective lens 107 separately from the image pickup element 109. Moreover, the image input circuit 172 extracts the image pickup conditions information inputted via the external input terminal 173, such as automatic exposure (AE) and exposure time in the camera 174, and stores the information as the set information in the memory circuit 112. The set information is superposed and displayed with the observation image of the observation sample 102 stored in the memory circuit 112 on the display screen of the display 113.

Even in this configuration, since the information such as the photography conditions extracted via another camera 174 is displayed with the observation image in the display screen of the display 113, the observer can utilize the information to satisfactorily observe the sample.

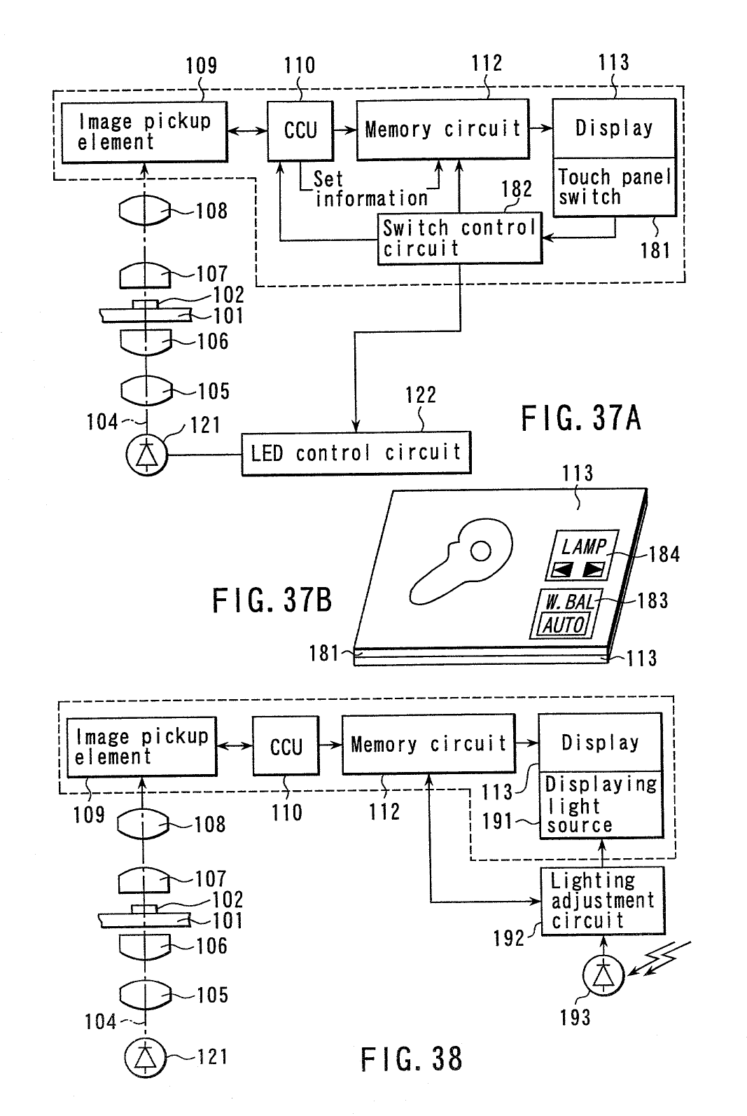

FIGS. 37A and 37B are diagrams showing the configuration of the microscope system according to a fifteenth embodiment of the present invention. In FIGS. 37A, 37B, the same components as those of FIG. 25 are denoted with the same reference numerals.

In this configuration, the display 113 has a touch panel switch 181 on the display screen. With the touch panel switch 181, the image pickup conditions for the image pickup element 109 and image adjustment conditions for the observation image in the CCU 110 can be set, and superposed and displayed on the display screen of the display 113. The touch panel switch outputs a signal in accordance with a pressed position (coordinate) of the switch on the display screen. The touch panel switch 181 is connected to a switch control circuit 182.

The switch control circuit 182 sends data of each switch image displayed on the display screen of the display 113 to the memory circuit 112. On receiving the position signal from the touch panel switch 181, the switch control circuit converts the position signal to a setting signal of the image pickup conditions and image adjustment conditions, and outputs the setting signal to the CCU 110. Moreover, the switch control circuit 182 inputs the information such as the image pickup conditions and image adjustment conditions for the CCU 110 as the set information to the memory circuit 112. These set information are superposed and displayed with the observation image of the observation sample 102 stored in the memory circuit 112 on the display screen of the display 113.

For example, ON/OFF of an automatic white balance will be described as an example of image adjustment for the CCU 110. In this case, for example, as shown in FIG. 37B, image data for displaying an automatic white balance ON/OFF switch 83 is stored in the switch control circuit 182. When the image data is sent to the memory circuit 112, the switch is displayed in the display screen of the display 113 as shown in FIG. 37B. When the observer presses the corresponding switch portion, a signal of the pressed position is sent to the switch control circuit 182 from the touch panel switch 181, converted to an automatic white balance ON/OFF signal for the CCU 110 in the switch control circuit 182, and sent to the CCU 110. Thereby, the CCU 110 sets the automatic white balance ON/OFF.

Moreover, the touch panel switch 181 can also be used to input an operation instruction for each operation section of the microscope. Another example will be described in which the LED control circuit 122 for adjusting the light amount of the LED 121 as the operation section of the microscope is connected to the switch control circuit 182, and the touch panel switch 181 is used to input the operation instruction to the LED control circuit 122.

In this case, for example, as shown in FIG. 37B, image data for displaying a lamp light amount adjustment switch 184 is stored in the switch control circuit 182. When the image data is sent to the memory circuit 112, the switch 184 is displayed in the display screen of the display 113 as shown in FIG. 37B. When the observer presses a switch 184 portion, the signal of the pressed position is sent to the switch control circuit 182 from the touch panel switch 181, and the signal is converted to an operation instruction signal for the LED control circuit 122 in the switch control circuit 182, and sent to the LED control circuit 122. Thereby, an LED light amount is adjusted in the LED control circuit 122.

In this configuration, the observer can use the touch panel switch 181 superposed and disposed on the display screen of the display 113 to set the image pickup conditions for the image pickup element 109 and image adjustment conditions for the observation image in the CCU 110. Moreover, since the information such as the image pickup conditions of the image pickup element 109 inputted via the touch panel switch 181 and the image adjustment conditions for the observation image are displayed with the observation image in the display screen of the display 113, the observer can confirm the information while satisfactorily observing the sample. Furthermore, the observer can also operate the respective operation sections of the microscope via the touch panel switch 181.

FIG. 38 is a diagram showing the configuration of the microscope system according to a sixteenth embodiment of the present invention. In FIG. 38, the same components as those of FIG. 25 are denoted with the same reference numerals.

In this configuration, the display 113 includes a displaying light source 191 for use as a back light of the display screen, the displaying light source 191 is connected to a lighting adjustment circuit 192, and the lighting adjustment circuit 192 is connected to a light amount detection element 193.

The light amount detection element 193 detects brightness in a periphery of the microscope. The lighting adjustment circuit 192 adjusts the light amount of the displaying light source 191 to be optimum for brightness in a use environment in accordance with a detected output of the light amount detection element 193. Moreover, the lighting adjustment circuit 192 inputs light amount adjustment information of the displaying light source 191 as state information to the memory circuit 112. The state information is superposed and displayed with the observation image of the observation sample 102 stored in the memory circuit 112 on the display screen of the display 113.

In this configuration, the brightness of the back light of the display screen by the displaying light source 191 is adjusted to be optimum in accordance with a detected output of the light amount detection element 193. Therefore, the observation image which can constantly easily be observed can be obtained even under the use environment (room brightness) of the microscope. Moreover, since the information on the light amount adjustment by the lighting adjustment circuit 192 is displayed with the observation image on the display screen of the display 113, the observer can confirm the information while satisfactorily observing the sample.

Additionally, in the respective embodiments, the case in which various information are simultaneously displayed with the observation image on the display screen of the display 113 has been described, but the observation image may be displayed with various information effective for system operation while switching the screen display.

As described above, according to the present invention, the observation image and information effective for the system operation can be displayed in the display. Thereby, there can be provided the microscope system with improved convenience of use.

That is, according to the present invention, since the observation image, and additionally the information effective for the system operation can be displayed in the display section. Therefore, the observer grasps various information on the screen, uses the content of the information as the standard, and can operate the system. Moreover, according to the present invention, since the observation image and the information effective for the system operation can simultaneously be displayed on the same display screen of the display section, the visibility and operability during sample observation becomes further advantageous. Furthermore, according to the present invention, the operation information, set information and state information can selectively be displayed as the information advantageous for the system operation.

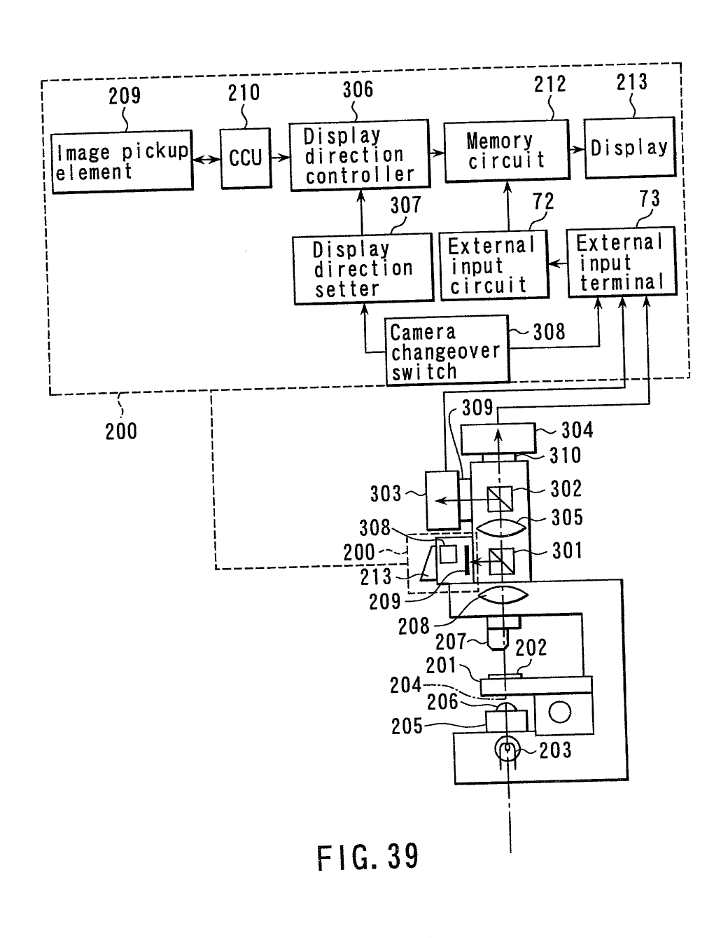

FIG. 39 is a diagram showing the configuration of the microscope system according to a seventeenth embodiment of the present invention. In FIG. 39, an observation sample 202 is laid on a stage 201. A lighting light source 203 formed of a halogen lamp, a mercury light, or the like is disposed below the stage 201. Moreover, a lighting optical system 205 and condenser lens 206 are disposed in a lighting light path 204 between the lighting light source 203 and the stage 201. The observation sample 202 is irradiated with a lighting light from the lighting light source 203 as a transmission lighting from below the stage 201 via the lighting optical system 205 and condenser lens 206.

An objective lens 207 is disposed opposite to the observation sample 202 and upward the stage 201. An observation image from the objective lens 207 is reflected by a light path split prism 301 via a projection lens (eyepiece) 208, and formed on an image pickup surface of an image pickup element 209 such as CCD in an electronic camera 200. The observation image transmitted through the light path split prism 301 is further reflected by a light path split prism 302 via a photograph eyepiece 305, and formed on a silver salt film camera 303 connected to a port 309. The observation image transmitted through the light path split prism 302 is formed on an instant camera 304 connected to a port 310.

The image pickup element 209 is connected to a camera control unit (hereinafter referred to as CCU) 210. Moreover, the CCU 210 is connected to a monitor display 213 via a display direction controller 306 and memory circuit 212.

The CCU 210 sets image pickup conditions such as automatic exposure (AE), exposure time, and gain for the image pickup element 209, and adjusts the color balance, gradation characteristics, and the like of the observation image picked up by the image pickup element 209. The display direction controller 306 is connected to a display direction setter 307, and the display direction setter 307 is connected to a camera changeover switch 308. Moreover, the camera changeover switch 308 is connected to an external input terminal 73. The external input terminal 73 inputs photography conditions information such as the AE and exposure time of the respective cameras from the silver salt film camera 303 and instant camera 304, and transmits the information to the memory circuit 212 via an external input circuit 72. The memory circuit 212 stores the image data inputted via the display direction controller 306 and information inputted from the external input circuit 72, and superposes and displays the image data on the display 213.

In the microscope system configured as described above, the observation image formed on the silver salt film camera 303 is the same as the observation image picked up by the image pickup element 209, but the observation image formed on the instant camera 304 is an observation image whose front/back is reversed with respect to the observation image picked up by the image pickup element 209.

In this case, during photography by the instant camera 304, the observer selects the instant camera 304 via the camera changeover switch 308 to frame the image. In accordance with the selection in the camera changeover switch 308, the display direction setter 307 sets the display direction controller 306 such that the front/back of the image data is reversed. Thereby, the display direction controller 306 reverses the front/back of the image data inputted from the CCU 210, and stores the data in the memory circuit 212.

Furthermore, since the camera changeover switch 308 selects the information corresponding to the instant camera 304 as the photography conditions information outputted via the external input terminal 73, the information is transmitted to the external input circuit 72 via the external input terminal 73. The external input circuit 72 takes the photography conditions information, stores the information as the set information in the memory circuit 212, and superposes and displays the information with the image data recorded in the memory circuit 212 on the display screen of the display 213.

Moreover, during photography by the silver salt film camera 303, the observer selects the silver salt film camera 303 via the camera changeover switch 308 to frame the image. In accordance with the selection in the camera changeover switch 308, the display direction setter 307 sets the display direction controller 306 such that the front/back of the image data is not reversed. Thereby, the display direction controller 306 stores the image data inputted from the CCU 210 in the memory circuit 212 without changing the image data.

Furthermore, since the camera changeover switch 308 selects the information corresponding to the silver salt film camera 303 as the photography conditions information outputted via the external input terminal 73, the information is transmitted to the external input circuit 72 via the external input terminal 73. The external input circuit 72 takes the photography conditions information, stores the information as the set information in the memory circuit 212, and superposes and displays the information with the image data recorded in the memory circuit 212 on the display screen of the display 213.

In this configuration, a specimen is photographed with the camera connected to the port in which the front/back of the observation image is different from that of the formed image. In this case, the image having the same image forming relation as that of the selected camera is displayed in the display. Therefore, the observer easily frames the image. Moreover, when the photography conditions of the selected camera are simultaneously superposed and displayed in the display, more satisfactory photography can be performed.

Additionally, the electronic camera for the microscope in the aforementioned embodiments may be configured as a digital camera for the microscope, and may be configured using a personal computer or a video camera.

Additional advantages and modifications will readily occur to those skilled in the art. Therefore, the invention in its broader aspects is not limited to the specific details and representative embodiments shown and described herein. Accordingly, various modifications may be made with out departing from the spirit or scope of the general inventive concept as defined by the appended claims and their equivalents.

What is claimed is:

1. A camera for a microscope, connected to the microscope having at least one port for outputting an image from an objective lens, for picking up the image outputted from said port, said camera comprising:
an image pickup element for picking up the image outputted from said port;
a display direction controlling section for converting a display direction of the image picked up by the image pickup element to a predetermined display direction;
a display direction setting section for setting said predetermined display direction with respect to the display direction controlling section; and
a display section for displaying the image having the display direction converted by said display direction controlling section.

2. The camera for the microscope according to claim 1, wherein said display direction setting section comprises a switch for arbitrarily inputting said predetermined display direction.

3. The camera for the microscope according to claim 1, wherein said display direction setting section comprises a display direction calculating function of computing said predetermined display direction based on identification information and outputting the predetermined display direction to said display direction controlling section when the identification information concerning said port is inputted.

4. The camera for the microscope according to claim 3, wherein said display direction setting section comprises:
a port information input section to which the identification information of the port connected to said camera for the microscope is inputted; and
a table in which a correspondence is established between the identification information of each port of said microscope and the display direction to be set, and
the display direction setting section computes the predetermined display direction based on the identification information inputted via said port information input section and said table.

5. The camera for the microscope according to claim 1, wherein said display direction setting section comprises:
a port recognizing section for recognizing identification information of the port connected to said camera for the microscope; and
a display direction calculating function of computing the predetermined display direction based on the identification information inputted via said port recognizing section and outputting the predetermined display direction to said display direction controlling section.

6. The camera for the microscope according to claim 5, wherein said connection port recognizing section comprises a table in which a correspondence is established between the identification information of each port of said microscope and the display direction to be set, and
computes the predetermined display direction based on the inputted identification information and said table.

7. The camera for the microscope according to claim 5, wherein each port of said microscope comprises a port ID storage section for identifying the identification information, and
said connection port recognizing section detects the identification information from said port ID storage section of the port connected to said camera for the microscope to recognize said port.

8. The camera for the microscope according to claim 5, wherein each port of said microscope comprises an electrode for identifying the identification information, and
said connection port recognizing section extracts an electric signal via said electrode of the port connected to said camera for the microscope to recognize said port.

9. The camera for the microscope according to claim 1, wherein said display direction setting section comprises:
a port unit recognizing section for identifying identification information of the port connected to said camera for the microscope, and recognizing type information of a configuring unit attached to said microscope; and
a display direction calculating function of computing the predetermined display direction based on the port identification information and the configuring unit type information inputted via said port unit recognizing section and outputting the predetermined display direction to said display direction controlling section.

10. The camera for the microscope according to claim 9, wherein said port unit recognizing section comprises a table in which a correspondence is established between each port of said microscope and the display direction to be set for a combination of the configuring unit attached to the port, and
computes the predetermined display direction based on the inputted port identification information, the configuring unit type information and said table.

11. The camera for the microscope according to claim 9, wherein said port unit recognizing section comprises a data table in which a type of rotation and front/back reverse operation of said image owned by the configuring unit attached to said microscope is stored, and
computes a display direction which offsets a sum of the rotation and front/back reverse operations of all the configuring units attached to the microscope as said predetermined display direction based on the inputted port identification information, the configuring unit type information and said data table.

12. The camera for the microscope according to claim 9, wherein each port of said microscope comprises a port ID storage section for identifying the identification information,
the configuring unit attached to said microscope comprises a unit ID storage section for identifying the type information,
said port unit recognizing section comprises a connection section electrically connected to said port ID storage section and said unit ID storage section, and
said port unit recognizing section detects the identification information and the type information via said connection section from the port ID storage section of the port attached to said camera for the microscope and the unit ID storage section of the configuring unit attached to said microscope.

13. The camera for the microscope according to claim 12, wherein said port ID storage section and said unit ID storage section comprise memories.

14. The camera for the microscope according to claim 12, wherein said port ID storage section and said unit ID storage section comprise contact electrodes.

15. A microscope system provided with a light path split member for splitting and guiding an image from an objective lens into a plurality of light paths, an image pickup element for picking up said image guided to one of said plurality of light paths, and a first camera and a second camera which can pick up said image guided to another light path among said plurality of light paths, said microscope system comprising:
a controlling section for setting image pickup conditions of said image pickup element, and converting the image picked up by said image pickup element to image data;
a display direction controlling section for converting a display direction of said image data outputted from said controlling section to a predetermined display direction;
a display direction setting section for setting said predetermined display direction with respect to the display direction controlling section;
an external input section to which information of photography conditions in said first camera and said second camera is inputted;
a camera changeover switch for selecting either one of said first camera and said second camera;
a memory circuit for storing said image data outputted from said display direction controlling section; and
a display section for displaying the data stored in said memory circuit,
wherein said display direction setting section sets said predetermined display direction based on camera selection information by said camera changeover switch in such a manner that an image photographing direction in said selected camera has the same direction as the display direction of the image displayed in said display section,
said external input section sends said photography conditions information in said selected camera to said memory circuit based on the camera selection information by said camera changeover switch, and
said image data is displayed in the same direction as the photographing direction of the camera selected by said camera changeover switch while the photography conditions information of said selected camera are displayed in said display section.

16. A microscope system provided with an image pickup element for picking up an image from an objective lens, comprising:
a controlling section for setting image pickup conditions of said image pickup element, and converting the image picked up by said image pickup element to image data;
a light source control circuit for adjusting a light amount of a lighting light source of said microscope system, and outputting a light amount adjustment state;
a memory circuit for storing the image data outputted from said controlling section and the light amount adjustment state outputted from said light source control circuit; and
a display section for superposing and displaying the image data and the light amount adjustment state stored in the memory circuit.

17. The microscope system according to claim 16, wherein the light amount adjustment state displayed in said display section is a voltage value which is supplied to said lighting light source by said light source control circuit.

18. The microscope system according to claim 17, wherein said display section superposes and displays said voltage value and said image data.

19. A microscope system provided with an image pickup element for picking up an image from an objective lens, comprising:
a controlling section for setting image pickup conditions of said image pickup element, and converting the image picked up by said image pickup element to image data;
a light source control circuit for inputting the image pickup conditions outputted from the controlling section, adjusting a light amount of a lighting light source of said microscope system based on the image pickup conditions, and outputting a light amount adjustment state;
a memory circuit for storing the image data outputted from said controlling section and the light amount adjustment state outputted from said light source control circuit; and
a display section for superposing and displaying the image data and the light amount adjustment state stored in the memory circuit.

20. The microscope system according to claim 19, wherein said lighting light source comprises an LED.

21. The microscope system according to claim 19, wherein said lighting light source comprises a plurality of LEDs, and said light source control circuit selects said plurality of LEDs.

22. A microscope system provided with an image pickup element for picking up an image from an objective lens, comprising:
a controlling section for setting image pickup conditions of said image pickup element, and converting the image picked up by said image pickup element to image data;
a display section for displaying the image data outputted from the controlling section;
a focus evaluation circuit for detecting a focus state of said microscope system based on a signal outputted from said image pickup element; and
a focus indicator for displaying the focus state outputted from the focus evaluation circuit.

23. The microscope system according to claim 22, wherein said focus indicator is aligned with said display section.

24. A microscope system provided with an image pickup element for picking up an image from an objective lens, comprising:
a controlling section for setting image pickup conditions of said image pickup element, and converting the image picked up by said image pickup element to image data;
a focus evaluation circuit for detecting a focus state of said microscope system based on a signal outputted from said image pickup element;
a memory circuit for storing the image data outputted from said controlling section and the focus state outputted from said focus evaluation circuit; and
a display section for superposing and displaying the image data and the focus state stored in the memory circuit.

25. A microscope system provided with a zoom lens in which a magnification of an image of a specimen from an objective lens positioned along an observation light axis can be adjusted, and an image pickup element for picking up said specimen image via the zoom lens, said microscope system comprising:
a controlling section for setting image pickup conditions of said image pickup element, and converting the image picked up by said image pickup element to image data;
a memory circuit for storing the image data outputted from the controlling section;
an objective lens magnification detection circuit for detecting a magnification of said objective lens;
a zoom magnification detection circuit for detecting a zoom magnification of said zoom lens;
a total calculation circuit for calculating a projection magnification at which said specimen is projected on said image pickup element from the magnification detected by said objective lens magnification detection circuit and the zoom magnification detected by zoom magnification detection circuit; and
a display section for superposing and displaying the image data stored in said memory circuit and magnification information outputted from said total calculation circuit.

26. A microscope system provided with an image pickup element for picking up an image from an objective lens, comprising:
a controlling section for setting image pickup conditions of said image pickup element, and enlarging or reducing the image picked up by said image pickup element to convert the image to image data;
a magnification conversion processing circuit for obtaining a magnification of enlargement or reduction by the controlling section;
a memory circuit for storing image data outputted from said controlling section and magnification information outputted from said magnification conversion processing circuit; and
a display section for superposing and displaying the image data and the magnification information outputted from the memory circuit.

27. A microscope system provided with an image pickup element for picking up an image from an objective lens, comprising:
a controlling section for setting image pickup conditions of said image pickup element, and converting the image picked up by said image pickup element to image data;
a memory circuit for storing the image data outputted from the controlling section;
a display section for displaying the image data stored in the memory circuit;
a recording medium for storing the image data stored in said memory circuit;
a recording medium control circuit for controlling the recording medium; and
an operating section for operating the recording medium control circuit,
wherein said recording medium control circuit controls writing of a stored content of said memory circuit to said recording medium, and reading of the stored content of said recording medium to said memory circuit by operation of said operating section, and outputting operation information in said operating section and read/write information of said recording medium as operation information to said memory circuit, and
said display section superposes and displays the image data and said operation information stored in said memory circuit.

28. The microscope system according to claim 27, wherein the operation information displayed in said display section is a set state of image recording.

29. The microscope system according to claim 28, wherein said set state of the image recording is an image format.

30. The microscope system according to claim 28, wherein said set state of the image recording is a compression ratio of the image recording.

31. A microscope system provided with an image pickup element for picking up an image from an objective lens, comprising:
a controlling section for setting image pickup conditions of said image pickup element, converting the image picked up by said image pickup element to image data, and outputting information of the image pickup conditions of said image pickup element and conversion conditions for use in conversion to said image data;
an output control circuit, connected to said controlling section, for receiving the information of said image pickup conditions and the information of said conversion conditions from said controlling section, so that said received information can be sent to an external output terminal connected to the output control circuit;
an operating section for operating said output control circuit to switch whether or not said information received by said output control circuit is outputted to said external output terminal;
a memory circuit for storing the image data outputted from said controlling section; and
a display section for displaying data stored in said memory circuit,
wherein said output control circuit is connected to said memory circuit, and outputs the same information as the information sent to said external output terminal to said memory circuit, so that the same information as the information sent to said external output terminal can be displayed in said display section.

32. A microscope system provided with an image pickup element for picking up an image from an objective lens, comprising:
an input section for inputting image pickup conditions of said image pickup element and conversion conditions for use in converting the image picked up by said image pickup element to image data;
a controlling section for setting the image pickup conditions of said image pickup element and converting the image picked up by said image pickup element to the image data based on said image pickup conditions and said conversion conditions inputted via said input section;
a memory circuit for storing said image data outputted from said controlling section; and
a display section for displaying the data stored in said memory circuit,
wherein said image pickup conditions inputted via said input section include at least one of an automatic exposure, an exposure time and a gain,
said conversion conditions inputted via said input section include at least one of a color balance and gradation characteristics, and
said controlling section outputs information of said image pickup conditions and information of said conversion conditions to said memory circuit, and displays the information of said image pickup conditions and the information of said conversion conditions in said display section.

33. A microscope system provided with an image pickup element for picking up an image from an objective lens, comprising:
a silver salt film camera for photographing the image from said objective lens, and outputting photography conditions such as an automatic exposure and an exposure time;
a controlling section for setting image pickup conditions of said image pickup element, and converting the image picked up by said image pickup element to image data;
an input circuit for taking the photography conditions outputted from said silver salt film camera, and outputting the photography conditions as set information;
a memory circuit for storing the image data outputted from said controlling section and the set information outputted from said input circuit; and
a display section for superposing and displaying the image data and the set information stored in the memory circuit.

34. A microscope system provided with an image pickup element for picking up an image from an objective lens, comprising:
a controlling section for setting image pickup conditions of said image pickup element, converting the image picked up by said image pickup element to the image data, and outputting the image pickup conditions of said image pickup element and conditions for conversion to said image data as set information;
a light source control circuit for adjusting a light amount of a lighting light source of said microscope system;
a switch control circuit for controlling said controlling section and said light source control circuit;
a memory circuit for storing the image data and the set information outputted from said controlling section and control information from said switch control circuit; and
a display section which superposes and displays said image data, said set information, and said control information stored in said memory circuit, and which comprises a touch panel switch configured in a display surface to generate a signal of a corresponding position of the pressed display surface,
wherein said switch control circuit controls said light source control circuit based on a switch operation in the touch panel switch of said display section, sets the image pickup conditions and the image data conversion conditions of said controlling section, and outputs a light amount adjustment condition by said light source control circuit, the set information comprising said image pickup conditions and said image data conversion conditions of said controlling section, and image data of said touch panel switch to said memory circuit.

35. A microscope system provided with an image pickup element for picking up an image from an objective lens, comprising:
a controlling section for setting image pickup conditions of said image pickup element, and converting the image picked up by said image pickup element to image data;
a memory circuit for storing the image data outputted from the controlling section;
a display section comprising a displaying light source for use as a back light of a display screen;
a lighting adjustment circuit for adjusting brightness of said displaying light source, and outputting adjustment information to said memory circuit; and
a light amount detection element for detecting an ambient brightness,
wherein said lighting adjustment circuit adjusts the light amount of said displaying light source to be optimum in accordance with a detection output of said light amount detection element, and outputs the adjustment information to said memory circuit,
said memory circuit stores the image data outputted from said controlling section and adjustment information outputted from said lighting adjustment circuit, and
said display section displays the image data and the adjustment information stored in said memory circuit.
